(19) United States
(12) Patent Application Publication
(10) Pub. No.: US 2007/0271517 A1
(43) Pub. Date: Nov. 22, 2007

(54) System and method for providing a web portal for managing litigation activities

(75) Inventors: Richard Finkelman, Rancho Palos Verdes, CA (US); Cynthia Rajhel, Oceanside, CA (US)

Correspondence Address: Cynthia Smith;BryceDowny, LLC., Suite # 2700, 200 North LaSalle, Chicago, IL, 60601, US

(73) Assignee: Navigant Consulting, Inc., Chicago, IL (US)

(21) Appl. No.: 11/804,639

(22) Filed: May 19, 2007

Related U.S. Application Data
(60) Provisional application No. 60/802,071, filed on May 19, 2006.

(51) Int. Cl. G06F 3/00

(52) U.S. Cl. 715/742

(57) ABSTRACT

A system and method for providing a web portal for managing litigation activities is described. The system includes a portal computing device having a customized collaborative web portal server application (e.g., Microsoft Office SharePoint Server 2007 plus customized web parts for a preservation notice feature), and a user computer operatively coupled to the portal computing device, where the user computer includes a user interface of a web browser and is adapted to display a hierarchy of interlinked portal web pages provided by the portal computing device. The system also includes a structured query language server adapted to populate the hierarchy of interlinked portal web pages with custodian information and with litigation-related data in order to facilitate managing litigation activities.

### CROSS-REFERENCE TO RELATED APPLICATIONS

This application is a non-provisional patent application that claims priority to and the benefit of U.S. Provisional Patent Application, entitled “Apparatus and Method for Providing a Web Portal for Managing Litigation Activities”, filed on May 19, 2006, having Ser. No. 60/802,071, and priority to and the benefit of U.S. Provisional Application, entitled “System and Method for Providing a Web Portal for Managing Litigation Activities”, filed May 15, 2007, having Ser. No. TBD, the entire contents of which are incorporated herein.

### BACKGROUND OF THE INVENTION

The present invention generally relates to portals, and more specifically, to a system and method for providing a web portal for managing litigation activities.

Use of computer-based web portals for managing litigation activities are becoming more widespread as litigation activities become more complex and are increasingly scrutinized by regulatory bodies. As is known, a ‘web portal’ is synonymous with a gateway for a World Wide Web site, and typically includes a hierarchy of viewable pages, where each page may include one or more hyperlinks (“links”) to another viewable page or to another portal. There are general portals and specialized or niche portals. Some well-known general portals include Yahoo, Excite, Netscape, Microsoft Network, and America Online's AOL.com. Microsoft Office SharePoint Portal Server is an example of a niche portal.

As is known, information associated with any litigation is ‘discovered’ as part of the pre-trial litigation process during which each party requests relevant information and documents from the other party(ies) in an attempt to discover pertinent information relating to the case. In addition to contracts, memos, records, letters, depositions, interrogatories, requests for admissions, document production requests and requests for inspection, and the like, discoverable information is now likely to include electronic correspondence (e.g., individual emails, email threads, email attachments, etc.). As a result, there are many ‘custodians’ of discoverable information who must be notified to hold or ‘preserve’, and then provide their discoverable information to requesting parties.

Accordingly, in large litigations or cases, the number of custodians and their resulting discoverable information is unwieldy using traditional notification, tracking and follow-up methods such as Excel spreadsheets and email correspondence and attachments. In addition, courts and law makers are now requiring parties (e.g., corporate attorneys), involved in discoverable information collection and dissemination to establish proof of their due diligence when requesting, tracking and/or providing discoverable information.

A variety of computer-based systems, methods and portals have been created to enable attorneys to manage complex litigation. For example, U.S. Pat. No. 5,940,800, to Bennett et al. entitled “Attorney Terminal Having Outline Preparation Capabilities for Managing Trial Proceedings,” describes an outline preparation capability for managing trial proceedings that is accessed via attorney terminals.

U.S. Patent Application No. 2002/0123902 to Lenore et al. entitled “Method, System and Storage Medium for Managing and Providing Access to Legal Information” provides a computer based system, method and storage medium for providing access to legal information.

U.S. Patent Application No. 2003/0112270 to Newell et al. entitled “Litigation Management System and Method” describes a litigation management system and method that includes a computer-based user interface having a home page and a number of web pages that enables management and access to litigation information stored in a computer.

U.S. Patent Application No. 2004/0143444 to Opsitnick et al., entitled “System and Method Facilitating Management of Law Related Services”, describes a litigation management component, or portal for access to the law related services.

### SUMMARY OF THE INVENTION

In general, provided is a system and method for providing a web portal for managing litigation activities, including comprehensive management and access to preservation notices and associated acknowledgements. Also provided are methods for importing custodians, who may possess discoverable information, into the system.

In one embodiment, a system for providing a web portal for managing litigation activities includes a portal computing device having a customized collaborative web portal server application, and a user computer operatively coupled to the portal computing device, where the user computer includes a user interface of a web browser and is adapted to display a hierarchy of interlinked portal web pages provided by the portal computing device. The web portal for managing litigation activities also includes a data store means that is operatively coupled to the portal computing device and is adapted to store litigation-related data, and includes an interface means for importing personnel information to the portal computing device, where the personnel information includes custodian information associated with a plurality of custodians having potentially discoverable information related to at least one litigation case. The web portal for managing litigation activities further includes a structured query language server operatively coupled to the portal computing device and the data store means, where the structured query language server is adapted to populate the hierarchy of interlinked portal web pages with at least one of the custodian information and the litigation-related data in order to facilitate managing litigation activities. An active directory server is operatively coupled to the portal computing device and the structured query language server, and is adapted to identify a user requesting access to the web portal and to authenticate access to the at least one of the custodian information and the litigation-related data via the hierarchy of interlinked portal web pages. The customized collaborative web portal server application includes one of a Microsoft SharePoint Portal Server 2003 plus customized web parts and a Microsoft Office SharePoint Server 2007 plus customized web parts. The customized web parts are adapted to enable: user selection of the plurality of custodians from the imported personnel information, automatic transmission of notices to preserve discoverable information to all of the plurality of custodians in response to one user selection, automatic transmission of the notices to preserve discoverable information to a portion of the plurality of custodians, and automatic transmission of reminder notices to preserve discoverable information to the plurality of custodians who have not acknowledged receipt of one of the notices to preserve discoverable information.

In another embodiment, a computer-implemented method for providing a web portal for managing litigation activities includes enabling configuration of a customized collaborative web portal server application, where the configuration facilitates display of a hierarchy of interlinked portal web pages. The method also includes enabling importation of personnel information, where the personnel information includes custodian information of a plurality of custodians having potentially discoverable information related to at least one litigation case, and includes displaying a first page of the hierarchy of interlinked portal web pages, where the first page includes litigation-related data and is adapted to enable user selection of the plurality of custodians from the personnel information. The method further includes displaying a second page of the page of the hierarchy of interlinked portal web pages, where the second page includes the litigation-related data and is adapted to enable automatic transmission of notices to preserve discoverable information to all of the plurality of custodians in response to one user selection. The method additionally includes displaying a third page of the hierarchy of interlinked portal web pages, where the third page includes the litigation-related data and is adapted to enable automatic transmission of the notices to preserve discoverable information to a portion of the plurality of custodians, and includes automatically tracking aspects of the litigation-related data and the custodian information and the notices to preserve discoverable information.

In yet another embodiment, a computer-readable medium having computer-executable instructions thereon that when executed by one or more processors causes a system (1) to provide a collaborative web portal including a customized collaborative web portal server application, where the collaborative web portal facilitates display of a hierarchy of interlinked portal web pages, (2) to import personnel information, where the personnel information includes custodian information of a plurality of custodians having potentially discoverable information related to at least one litigation case, (3) to display a first page of the interlinked hierarchy of portal web pages, where the first page includes litigation-related data and is adapted to enable user selection of the plurality of custodians from the personnel information, (4) to display a second page of the hierarchy of interlinked portal web pages, where the second page includes the litigation-related data and is adapted to enable automatic transmission of notices to preserve discoverable information to all of the plurality of custodians in response to one user selection, and (5) to display a third page of the hierarchy of interlinked portal web pages, where the third page includes the litigation-related data and is adapted to enable automatic transmission of the notices to preserve discoverable information to a portion of the plurality of custodians. The computer-readable medium having computer-executable instructions thereon that when executed by one or more processors also causes a system (6) to automatically track aspects of the litigation related data and information associated with the plurality of custodians and the notices to preserve discoverable information.

It should be understood that the present invention includes a number of different aspects or features which may have utility alone and/or in combination with other aspects or features. Accordingly, this summary is not exhaustive identification of each such aspect or feature that is now or may hereafter be claimed, but represents an overview of certain aspects of the present invention to assist in understanding the more detailed description that follows. The scope of the invention is not limited to the specific embodiments described below, but is set forth in the claims now or hereafter filed.

### BRIEF DESCRIPTION OF THE DRAWINGS

FIG. 1 is a block diagram of an exemplary system for providing a web portal for managing litigation activities, according to an embodiment of the invention.

FIG. 2 is a block diagram of an exemplary portal sever of the system of FIG. 1, according to an embodiment of the invention.

FIG. 3 is a high level method flow of the litigation activities supported by the system of FIG. 1, according to an embodiment of the invention.

FIG. 4 is a portal process map showing an overview of a portion of the screen shots related to one or more cases supported by the portal network of FIG. 1, according to an embodiment of the invention.

FIG. 5 is a screen shot of an exemplary Portal Homepage that may be displayed to a user after gaining on-line access to the portal server of FIG. 1, according to an embodiment of the invention.

FIG. 6 is a screen shot of an exemplary Case Homepage that may be displayed via a case selection from the Portal Homepage of FIG. 5, according to an embodiment of the invention.

FIG. 7 is a screen shot of an exemplary Documents and List page that may be displayed via a menu bar selection from the Case Homepage of FIG. 6, according to an embodiment of the invention.

FIG. 8 is a screen shot of an exemplary Custodians List page that may be displayed upon selecting a Custodians link from the Case Homepage of FIG. 9, according to an embodiment of the invention.

FIG. 9 is a screen shot of an exemplary Import Custodians page that may be displayed upon selecting an Import Custodians link from the Custodians List page of FIG. 8, according to an embodiment of the invention.

FIG. 10 is a screen shot of an exemplary Batch Send Preservation Notice page that may be displayed upon selecting a Preservation Notice link from the Custodians List page of FIG. 8, according to an embodiment of the invention.

FIG. 11 is a screen shot of an exemplary Send Single Preservation Notice page that may be displayed upon selecting a Click Here to Send Single Preservation Notices link from the Batch Send Preservation Notice page of FIG. 10, according to an embodiment of the invention.

FIG. 12 is a screen shot of an exemplary Preservation Notice Email template, including an embedded Acknowledgement link, that may be sent to a custodian displayed on Custodians List page of FIG. 8, according to an embodiment of the invention.

FIG. 13 is a screen shot of an exemplary Notice Acknowledged indication displayed to a custodian who has acknowledged receipt of the preservation notice email of FIG. 12, according to an embodiment of the invention.

FIG. 14 is a screen shot of an exemplary Preservation Notice Summary page that may be displayed upon selecting a Preservation Notice link from the Documents and List page of FIG. 7, according to an embodiment of the invention.

FIG. 15 is a screen shot of another exemplary Custodians page that may be displayed upon selecting a Custodians link from the Documents and List page of FIG. 7, according to an embodiment of the invention.

FIG. 16 is a screen shot of an exemplary Preservation Notice History page that may be displayed upon selecting a Preservation Notice History link from the Documents and List page of FIG. 7, according to an embodiment of the invention.

FIG. 17 is a screen shot of an exemplary Custodian Interview Calendar page that may be displayed upon selecting a Custodian Interview Calendar link from the Custodians List of FIG. 8, according to an embodiment of the invention.

FIG. 18 is a screen shot of an exemplary Custodian Interview Status page that may be displayed upon selecting an Interview Status link from the Custodians List page of FIG. 8, according to an embodiment of the invention.

FIG. 19 is a screen shot of an exemplary Track Collections page that may be displayed upon selecting a Collections link from the Documents and List page of FIG. 7, according to an embodiment of the invention.

FIG. 20 is an exemplary screen shot of a Media Tracking page that may be displayed upon selecting a Media Tracking link from the Case Homepage of FIG. 6, according to an embodiment of the invention.

FIG. 21 is a screen shot of an exemplary Review Status page that may be displayed upon selecting a Review link from the Documents and List page of FIG. 7, according to an embodiment of the invention.

FIG. 22 is a screen shot of an exemplary Production Summary page that may be displayed upon selecting a Production link from the Documents and List page of FIG. 7, according to an embodiment of the invention.

FIG. 23 is a flow chart of a method for providing the web portal of FIG. 1, according to an embodiment of the invention.

### DETAILED DESCRIPTION OF THE INVENTION

A collaborative web portal platform is designed to facilitate collaboration among its users and to provide a single, integrated platform to manage intranet, extranet, and Internet applications across an enterprise. One such collaborative web portal, Microsoft SharePoint Portal Server 2003 (and its successor, Microsoft Office SharePoint Server 2007), is built on an open, scalable architecture, with support for Web services and interoperability standards including XML and Simple Object Access Protocol (SOAP). It's open application programming interfaces (APIs) and event handlers for lists and documents enable integration with existing systems and the flexibility to incorporate non-Microsoft IT assets.

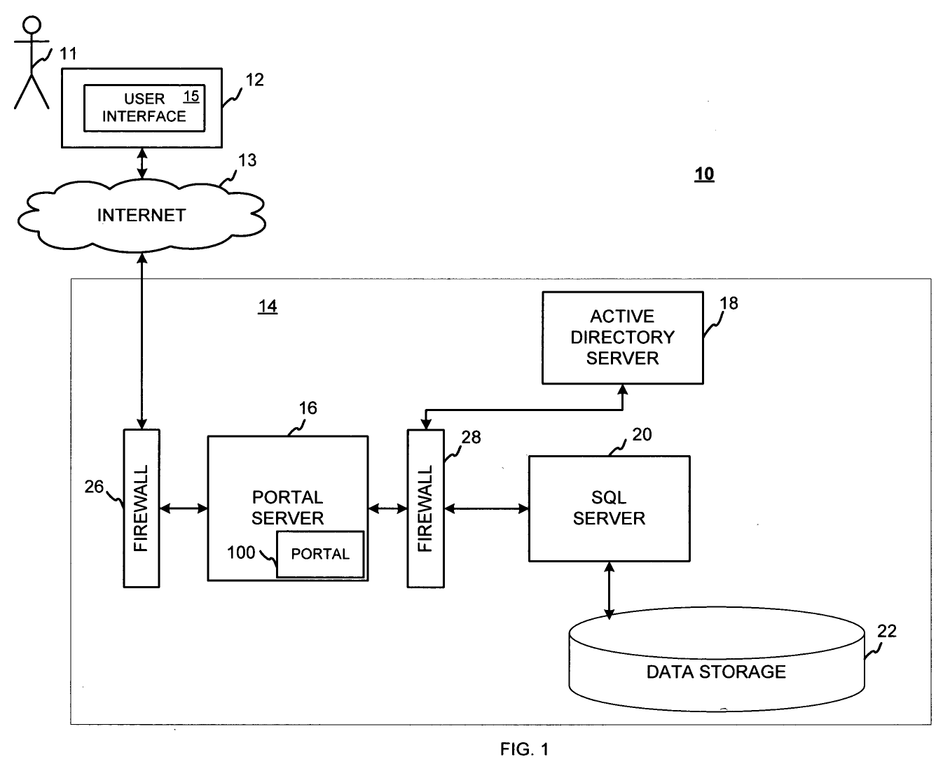

FIG. 1 is a block diagram of an exemplary system 10 for providing a portal for managing litigation activities associated with one or more cases, including comprehensive management and access to preservation notices and associated acknowledgements, according to an embodiment of the invention. The system 10 includes a user computer 12 (i.e., client computer with browser) operatively coupled to a portal network 14 via the Internet 13. In general, the portal network 14 includes one or more servers configured to provide a permission-based portal for managing all litigation activities that span the discovery lifecycle (to production and beyond) associated with a number of cases. Such activities include planning, information preservation, evidence collection, information filtering and de-duplicating, pre-production, production, motion work, testimony work and trial work.

In general, the portal network 14 enables permissioned sharing of litigation related documents and other information via its ability to enable information organization and aggregation from disparate sources in one central, web-based application. More specifically, the portal network 14 enables users to access the litigation activities related to one or more cases, and using included collaborative tools accessed via the portal, to manage, share and search documents and activities that span the discovery process; to collaborate with an entire case project teams including inside counsel, outside counsel, consultants and the like; to create, manage, send and status-track preservation notices, reminders and updates via emails; to enable easy preservation notice acknowledgement via email; to log and track interviews, collections and depositions; to create process-driven calendars and scheduling; to create and utilize virtual workspaces; to post announcements and facilitate discussion groups; to sign-up for email alerts and receive notifications when documents, data and status information changes; to assign tasks and track issues and decision.

The portal network 14 includes a portal server 16 operatively coupled to an active directory server 18 and an SQL server 20 via a suitable interface network such as, for example, a 100 Mbps or 1 Gbps Ethernet network. A first and second firewall 26 and 28 are included to prevent communications/data traffic forbidden by a security policy established for the portal network 14. In one embodiment the SQL server 20 is operatively coupled to a data storage unit 22.

Although illustrated as including three servers, it is contemplated that the portal network 14 may include less servers depending on the desired implementation, availability, and capacity. For example, the functionality of the data storage 22 may be included in the SQL server 20. Likewise, the functionality of the active directory server 18 may be included in the SQL server 20. It is also contemplated that the portal network 14 may include additional servers, (e.g., a file server) or redundant servers to provide fault or failure tolerance. While described in terms of a portal server 16, as will be appreciated by one skilled in the art, the portal server 16 may be one any number of computing device types such as a client, a server, a mobile device or any other computing device that interacts with data in a network based on a collaborative web portal application.

The portal server 16 is a web server configured to, among other things host a (web) portal 100 via interacting with data in the portal network 14 based on a customized collaborative web portal server application. For example, using a customized collaborative web portal server application, the portal 100 enables multiple users to share information with each other by providing a central location for data (e.g., custodians, hold or preservation notices, preservation notice acknowledgement status, deposition information, etc. associated with litigation activities (on a per case basis). In the illustrated example, the customized collaborative web portal server application includes Microsoft SharePoint Portal Server 2003 (and its successor, Microsoft Office SharePoint Server 2007), plus customized web parts for inter alia hold notices and associated custodian acknowledgements, and custodian list management. In one embodiment, the hierarchy of viewable portal web pages that are accessible via the portal 100 are resident on the portal server 16, however they may be located on other servers of the portal network 14.

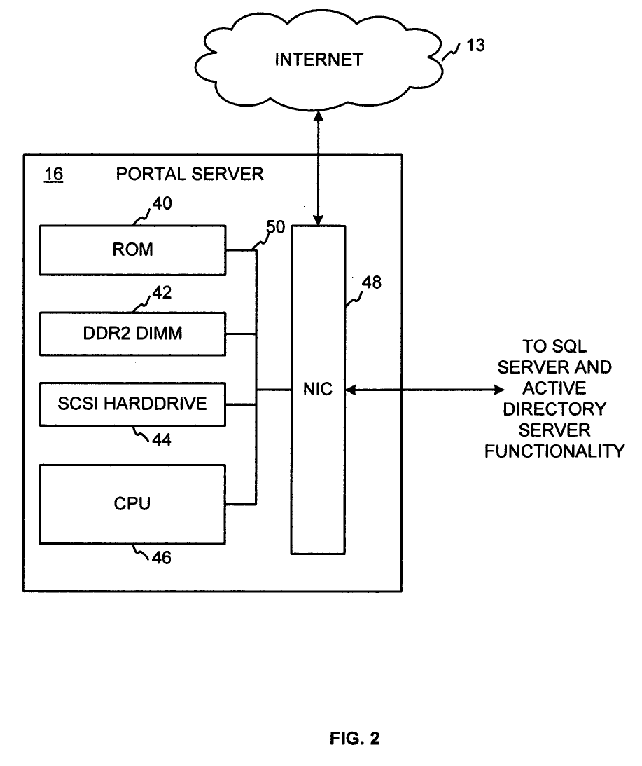

FIG. 2 is a block diagram of an exemplary portal sever 16 of the system 10, according to an embodiment of the invention. In a very basic configuration, the portal server 16 includes at least one microprocessor and a memory means. Referring to FIG. 2, the portal server 16 is configured to implement the exemplary methods described herein, and in one example includes a read only memory (ROM) 40, a double-data-rate dual in-line memory module (DDR2 DIMM) 42, a small computer system interface (SCSI) hard-drive 44, and a central processing unit (CPU) 46, all of which may be interconnected to network interface card (NIC) 48 via a communications link or an address bus 50. In one embodiment, the DDR2 DIMM 42 is preferably a 1 GB DDR2 DIMM, the SCSI hard-drive 44 is preferably a 73 GB 10k RPM SCSI hard drive (RAID 1, redundant array of independent disks), the CPU 46 is preferably an Intel® 3.2 GHz Xeon, and the NIC 48 is preferably an embedded Intel® 10/100/1000. As will be appreciated by one skilled in the art, the portal server 16 may be configured one of any number of suitable configurations such as redundant DDR2 DIMMs 42, SCSI hard-drives 44, and CPUs 46, depending on desired computing requirements and the state of server art.

Although not separately illustrated the portal server 16 includes a network receiver (e.g., an Ethernet interface circuit electrically coupled to the Internet via an Ethernet cable), operatively coupled to the Internet, and adapted to receive web page requests (e.g., HTTP, HTTPS), usernames and passwords, etc, in one of any well-known manners. Similarly, the portal server 16 includes a network transmitter for purposes of transmitting portal web pages (HTML formatted page) associated with the portal 100 in one of any well-known manners.

Referring again to FIG. 1, the active directory server 18 is configured to control access to the portal 100 via central authentication and authorization services. The active directory 18 is also configured to store information and settings relating to an organization(s) in a central, organized, accessible database. Groups are added for companies or organizations that have employees who will be users of the portal 100. A user account (profile) is created for each user 11, and permission levels are assigned to the users 11. The permission levels are managed by the portal server 16 however any server of the portal network 14 may be configured to include this functionality.

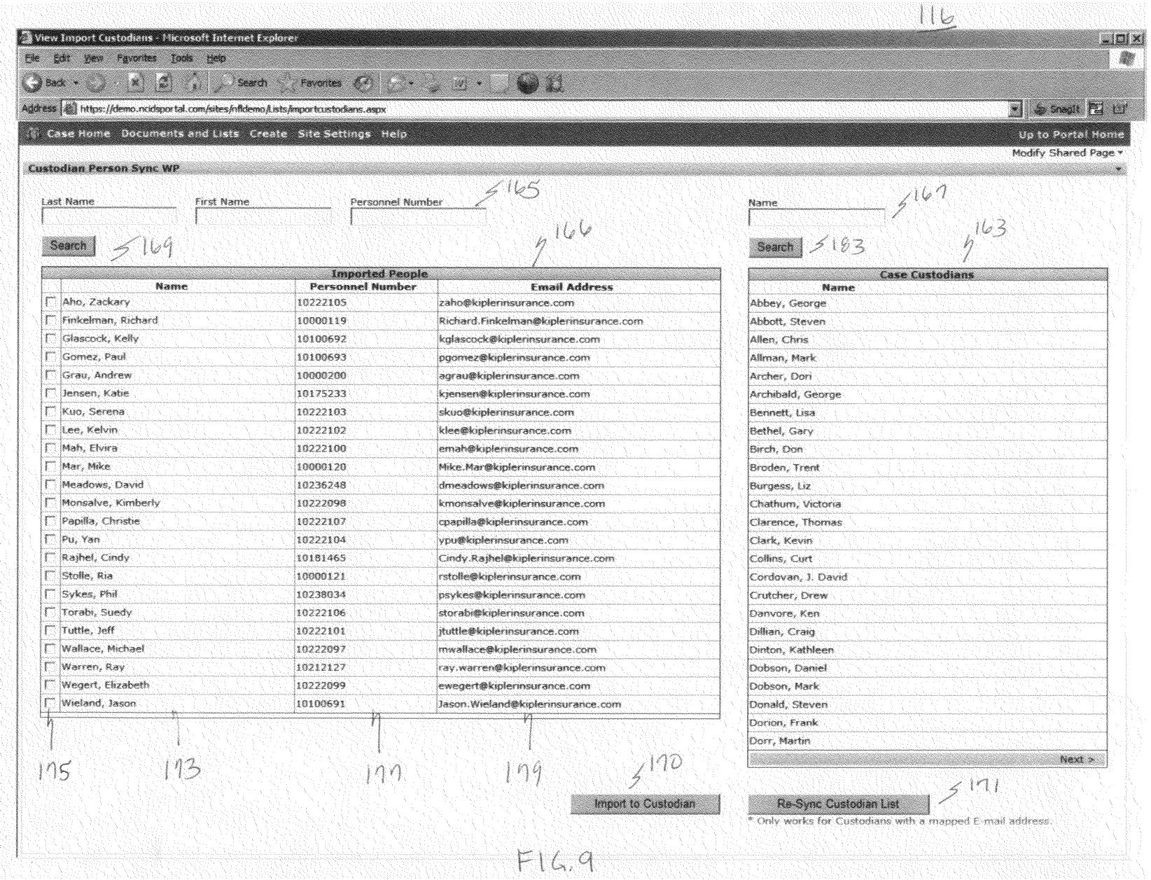

The users 11 may be added to an active directory 19 of the active directory server 18 via one of any number of suitable methods including manual entry using the portal 100 or the active directory server 16, 18, depending on management responsibilities for the portal network 14. For example, an administrative customized web part is configured to provide administrative users with the ability to add users 11 to the active directory without logging into the active directory. Similarly, custodians (those who possess discoverable information) may be added to the active directory 19 via one of any number of suitable methods (discussed below in connection to FIG. 9), such that the active directory 19 includes names, email addresses, employee identification numbers, phone numbers, job information, etc. for users and/or custodians.

In general, there are three main classifications of users; system administrative users, portal administrative users and ordinary users. System administrative users are those who install/maintain software/hardware on which the portal 100 runs. They also configure the active directory server 18, and may have both remote and on-site access to the portal network 14. When on-site at a hosting facility of the portal network 14, system administrative users may be required to gain access via biometric scanners and proximity card readers. The user 11 may be granted permission to add, update and delete user accounts from the active directory 19. If the portal network 14 is hosted by a corporation, the corporation may prefer to have an in-house system administrator for security purposes. Conversely, if the portal network 14 is hosted by a contractor, the corporation may assign most of the system administration duties to the contractor and retain limited access to add users through the admin customized web part.

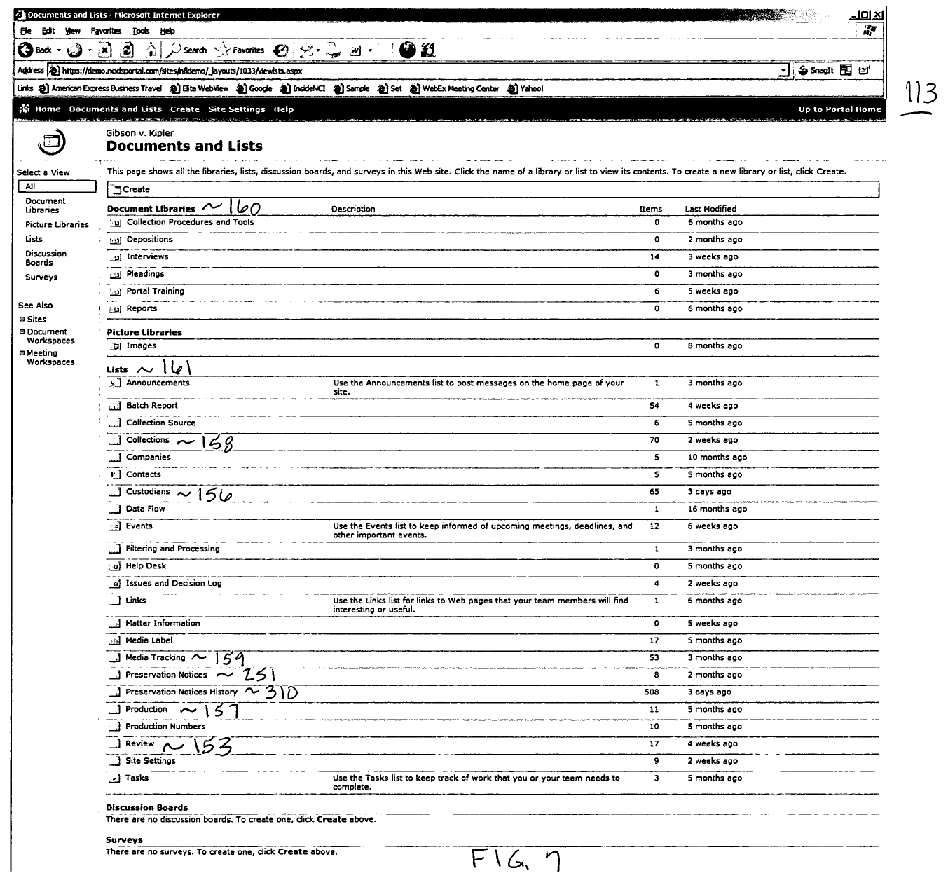

Portal administrative users can modify settings, add and change fields, and add and change field values of lists. They can create new lists (e.g., a list that includes columns and rows containing data that reflects each custodian's preservation notice history), and modify existing lists (see, FIG. 7) via a Modify Columns and Settings page (not separately shown) accessible via any list or document library. They can also add documents to a document library of the portal 100. In addition, among other administrative activities, they can create filtered views of information and add users to the cases.

Ordinary users may also include users who don't have any of the above capabilities, other than adding documents to the document library. Rather, they log into the portal 100, authenticate via the Active Directory server 18 and use the portal 100 as described below. For example, the ordinary user may be a contributor (e.g., a associate lawyer, an information technology (IT) engineer, a paralegal) with read and write permission to add, delete or modify data used to populate portal web pages accessible to them. In some cases, the ordinary user may simply have read permission to view portal web pages (e.g., a partner in a law firm). User permissions to access information used to populate the portal web pages are then controlled via the portal server 16.

The data storage 22 stores the majority of the data/information required for the portal network 14, or litigation-related data, as well as transaction logs and backup software of the portal network 14 servers. The litigation-related data may include interview information, collection procedures, collection tools, deposition information, pleadings information, custodian-related information, collections information, media tracking information, filtering information, processing information, review information, production information, events information, issues and decision logs information, contact information, matter information, announcements, batch report information, litigation-related company information, links, preservation notices, preservation notice information, preservation notices history information, site settings and tasks.

In one embodiment, the data storage 22 is configured as a number of networked database devices to provide high availability to the data. The SQL server 20 utilizes a Structured Query Language to access the information stored in the data storage 22. The information is provided from the data storage 22 upon query by the SQL server 20 to for example, populate the portal web pages displayed via portal access. In one embodiment, the SQL server 20 is configured as two servers; one active and one backup in a failover mode scheme with virtual database server and virtual file server functionality. Other suitable configurations are possible. It is contemplated that in certain cases, data storage 22 functionality may be included in the SQL server 20.

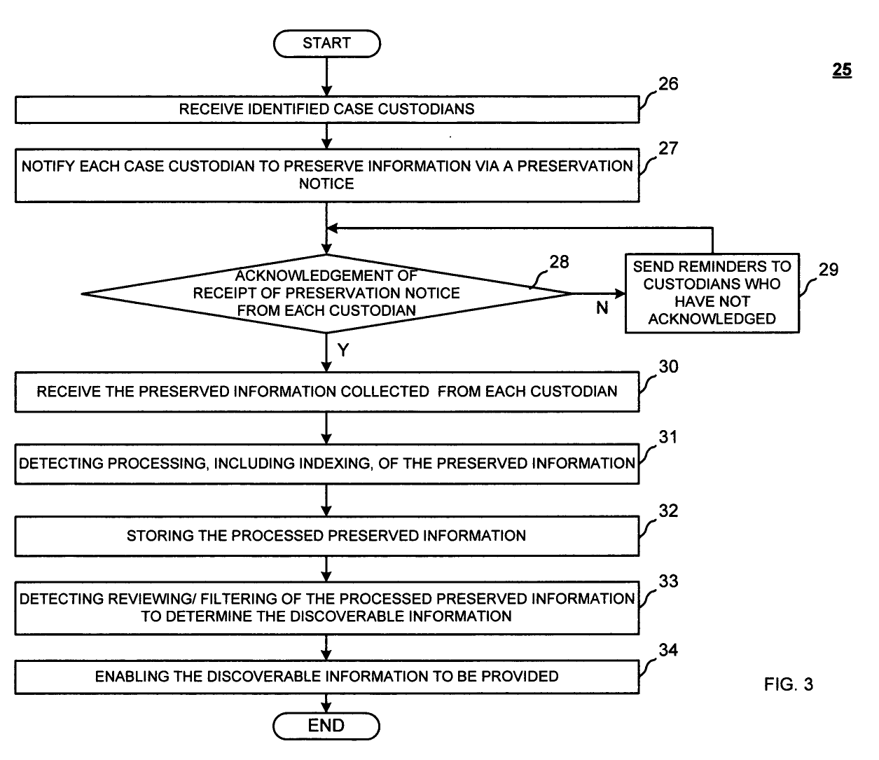

FIG. 3 is high level method flow 25 of the litigation activities associated with a case supported by the portal network 14, according to an embodiment of the invention. As discussed above, information associated with a case is discovered as part of the pre-trial litigation process. Some of the discoverable information, such as electronic correspondence, is provided by custodians. Discoverable information may also include depositions, interrogatories, requests for admissions, document production requests, expert reports, requests for inspection, and so on.

Once custodians of potentially discoverable information have been identified (step 26), they must be notified to preserve or hold the information (step 27). The notification to hold the information must additionally be acknowledged by the respective custodians (step 28). Those custodians who do not acknowledge receipt of preservation notices are periodically reminded until they have acknowledged (step 29). After acknowledgement by the custodians, potentially discoverable information must be collected (step 30) while maintaining a chain of custody (e.g., collected via an intermediary party such as an Information Technologist), and processed (step 31) using processing software which indexes associated text and/or data (e.g., a load file) of the potentially discoverable information for subsequent search purposes. In many cases, the processing is done by a processing vendor. The resulting processed information is stored (step 32) in a database. Depending on preferences, the database may or may not be accessible and/or included via the portal network 14. After storage in the database, the information may be accessed, reviewed and culled (step 33) by an attorney using one of any number of well-known review tools and agreed upon “filter terms”. That information which is deemed discoverable is then provided (step 34) to the litigants for witness and trail preparation etc., and for the trail proceedings.

One manner in which the portal network 14 may operate is described in connection with one or more screen shots and flowcharts that represent a number of portions or routines of one or more computer programs, which may be stored in one or more of the memories of the portal server 16, or may be stored remotely in the portal network 14.

In operation, when HTTP requests are received from a user 11 attempting to gain access to the portal 100 via the user computer 12, the portal server 16 interacts with the active directory server 18 to authenticate the user 11. Authentication includes user name and password validation based on user directory maintained in the active directory server 18.

Upon successful authentication, the user 11 gains access to the portal 100 via a series of portal web pages (HTML pages). For each requested portal web page, the portal server 16, utilizing stored user permissions, queries the SQL server 20 to determine the appropriate information the user 11 is allowed to see, edit, etc.

User-defined criteria are utilized to organize the content of the portal 100. In addition, users 11 are able to add metadata to document libraries and lists to further categorize and classify information, creating an organized hierarchy of information and enhancing navigation and search capability within the web portal 100.

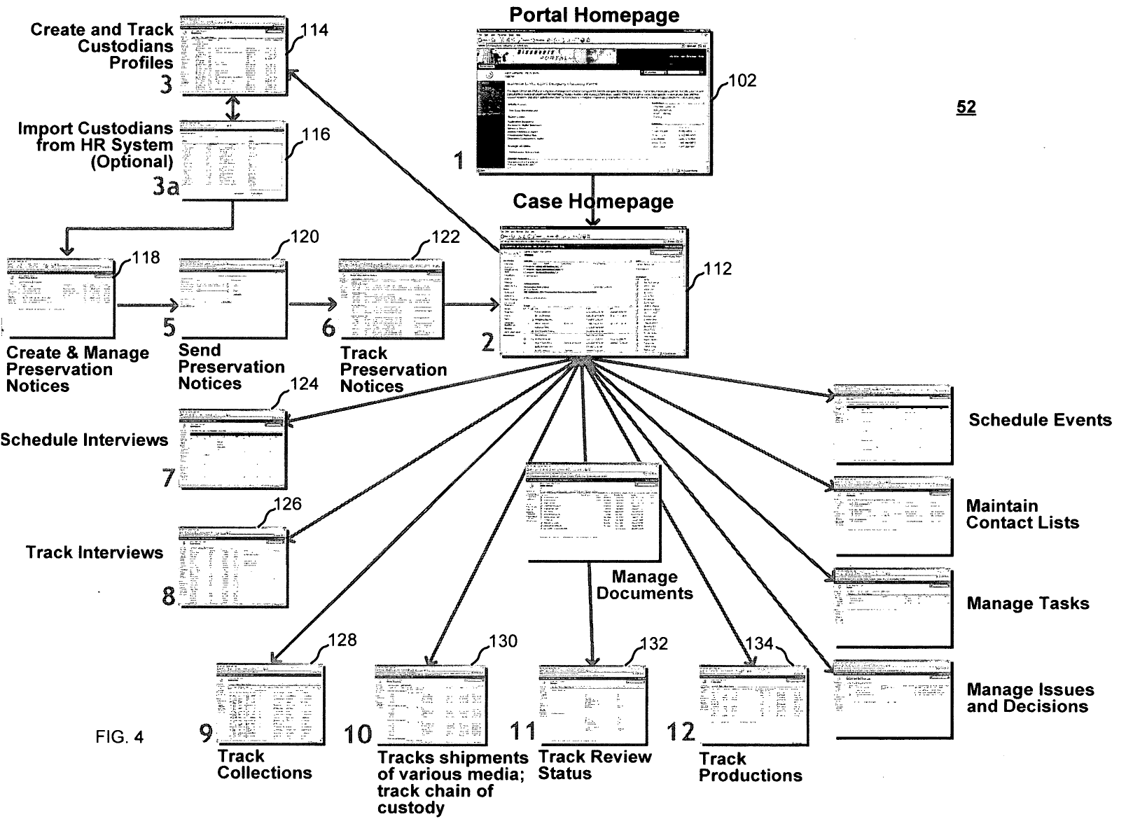

FIG. 4 is a portal process map 52 showing an overview of a portion of the screen shots of portal web pages related to one or more cases supported by the portal network 14, according to an embodiment of the invention. Each of the screen shots of FIG. 4 will be described in more detail below.

After user authentication, a Portal Home page is displayed on the user computer 12. The contents of the Portal Home page may vary depending on the user 11 and his/her profile. The Portal Home page is populated with the appropriate information provided from the data storage 22 upon request by the SQL server 20 in response to the query from the portal server 16.

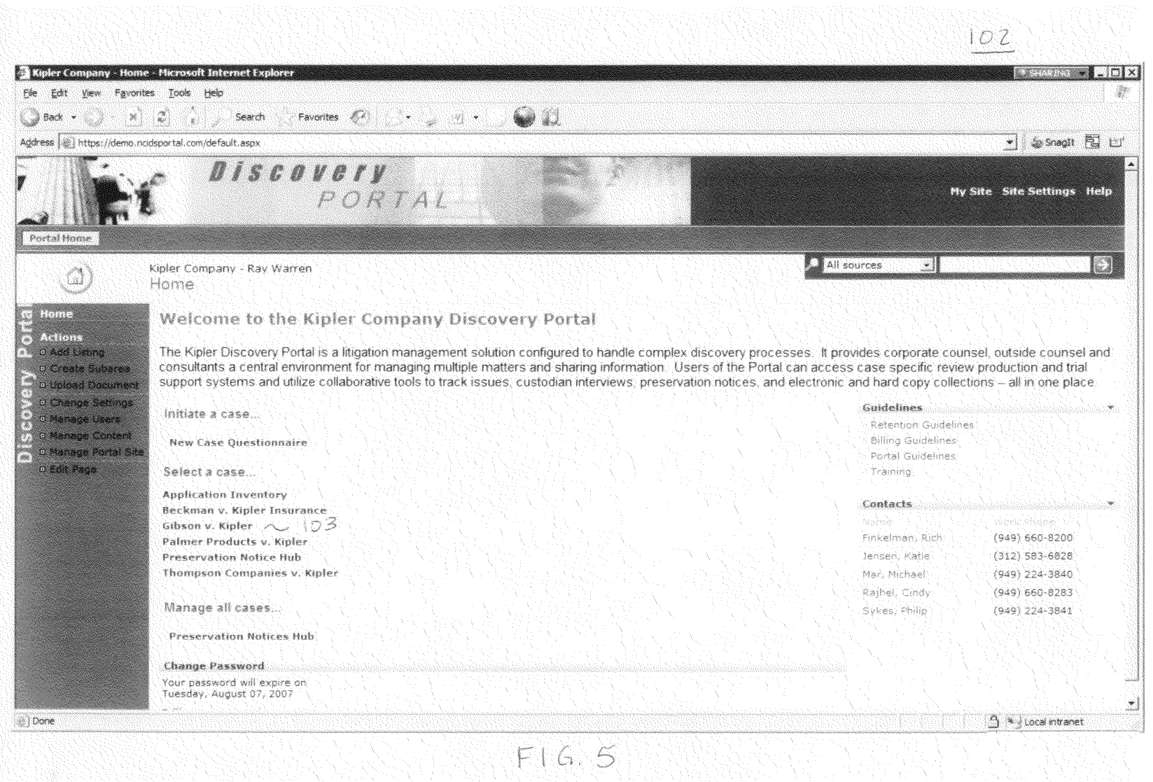

FIG. 5 is a screen shot of an exemplary Portal Homepage 102 that may be displayed to the user 11 after gaining on-line access to the portal 100, according to an embodiment of the invention. The Portal Homepage 102 is a portal location from which users can track litigation activities that span the discovery lifecycle for the case (e.g., custodians, interviews, collections, review and production). While not repeated discussed, it should be understood that the exemplary pages of the portal 100 are displayed to the user 11 via a user interface 15 of the user computer 12.

Prearranged user permissions in the user's profile determine user rights to search, view, download and/or upload data via the portal 100. For example, the user 11 may have permission to access three litigation cases including Gibson v. Kipler, Thompson Companies v. Kipler and Palmer Products v. Kipler with rights to add data. In this example, the Portal Home page 102 includes links that enable user access to the three litigation cases. In this and subsequent screen shots of the portal 100 functionality, a demonstrative case is illustrated as evidenced by the uniform resource locator (URL). “https://demo.ncidsportal.com/default.aspx”. In other cases of the portal 100, the “demo” text in the URL may be replaced by a law firm or company name.

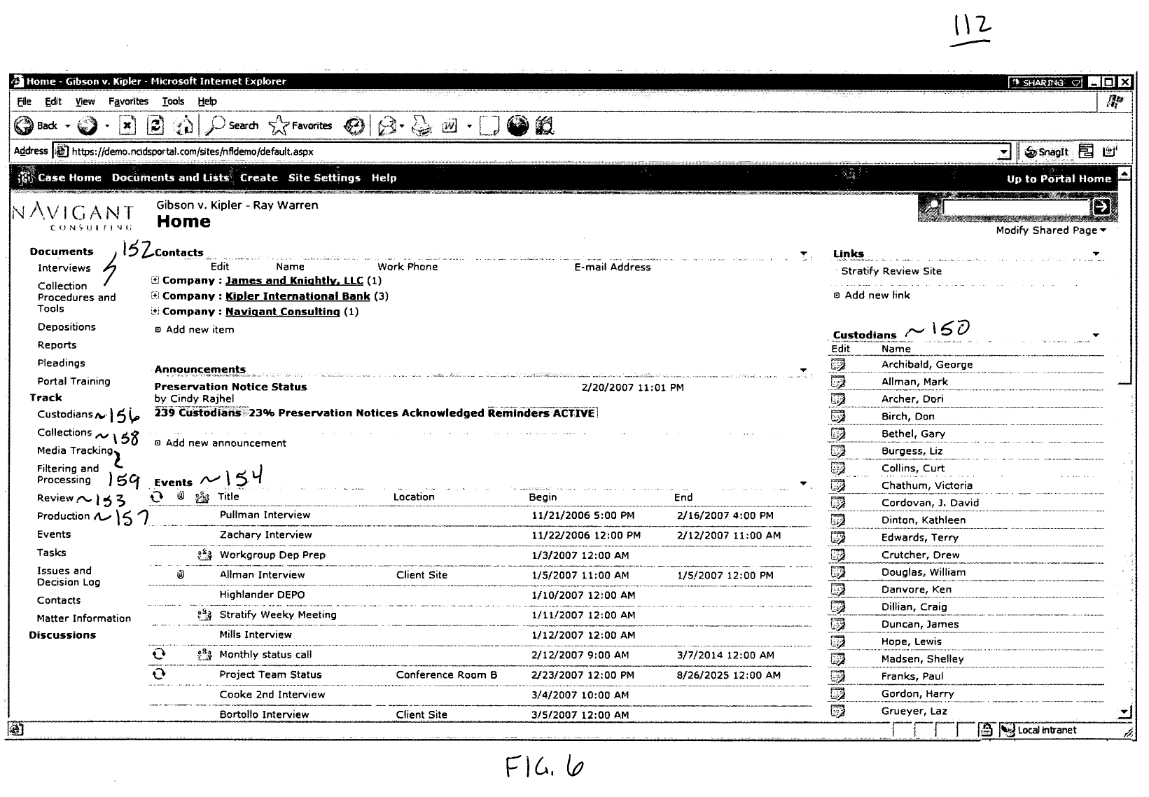

After selecting a case from the Portal Homepage 102 of FIG. 5, the portal server 16 causes an associated Case Homepage to be displayed on the user computer 12. The Case Homepage facilitates entry into litigation information associated with that case. FIG. 6 is a screen shot of an exemplary Case Homepage 112 that may be displayed to the user 11 via a case selection link 103 (e.g., the Gibson v. Kipler case) from the Portal Homepage 102. Among other items, the Case Home page 112 includes a list of Custodians 150 associated with the case; in this example, the Gibson v. Kipler case. As described above, a custodian is defined as a person identified as having discoverable information that may be relevant to the case represented by the Case Homepage 112. A list 154 of case-related events including event titles, event locations and event start and end times, is also displayed on the Case Homepage 112.

The Case Homepage 112 includes a quick launch link panel 152 that displays links to additional portal web page (discussed below) associated with that case. The links displayed on the quick launch panel 152 are also included, along with other links, in a Documents and List page described in connection with FIG. 7. Rather than navigating to the Documents and Lists page of FIG. 7 however, selection of one of the links listed in the quick launch link panel 152 provides a short cut to the information represented by the selected link. The user 11 or an administrator can select which items warrant easy access and should be included in the quick launch panel 152. For example, the quick launch panel 152 includes links to interviews, depositions, reports, pleadings. Collection procedures and tools, as well as portal training links are also included. The quick launch link panel 152 further includes tracked item links such as a Custodians link 156, a Review link 153, a Collections link 158, a Media link 159, a Production link 157, to name a few.

FIG. 7 is a screen shot of an exemplary Documents and List page 113 that may be displayed to the user via a menu bar selection 155 from the Case Homepage of FIG. 6 (as well as a number of other pages), according to an embodiment of the invention. The items listed in the Documents and List page 113 include links to document libraries 160, and to other case related information including a number of list links 161. For example, the list links 161 may include the often-viewed links of FIG. 6 such as the Custodians link 156, the Collections link 158, the Media Tracking link 159, the Review link 153, the Production link 157, as well as less-viewed links such as a help desk link.

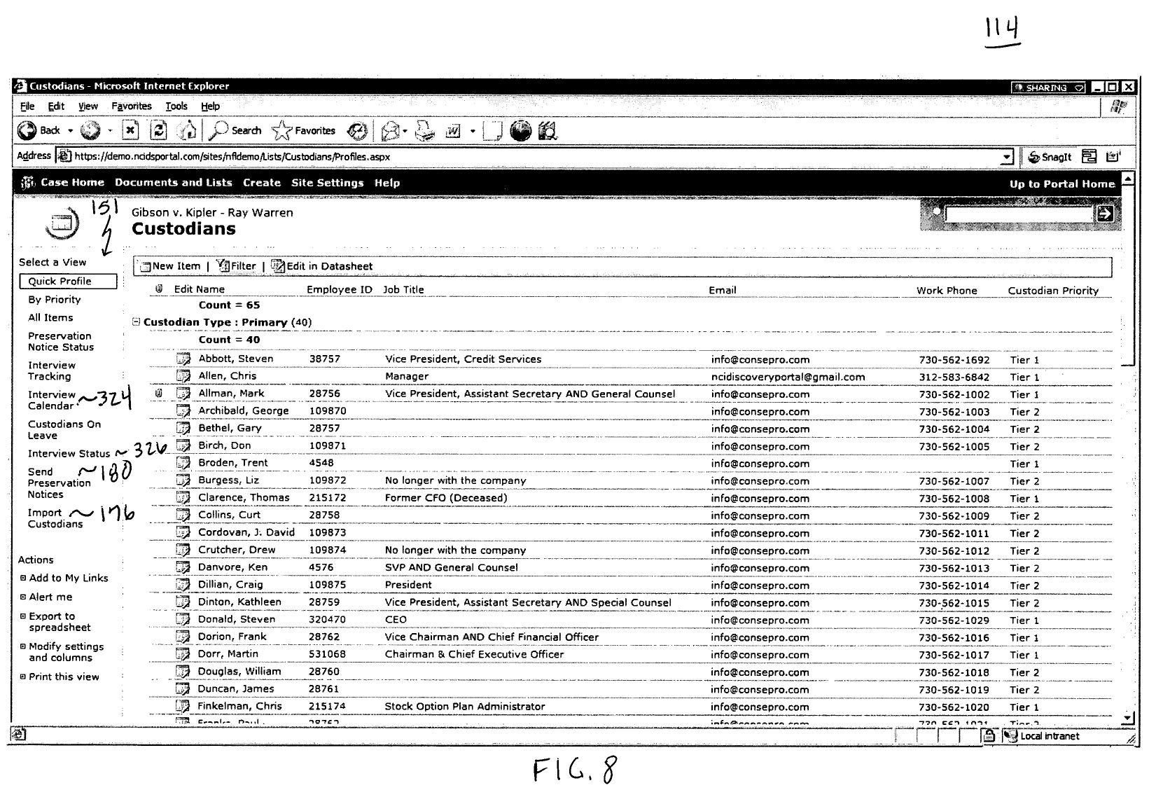

Referring back to FIG. 6, FIG. 8 is a screen shot of an exemplary Custodians List page 114 that may be displayed to the user 11 upon selecting the Custodians link 156 from the quick launch link panel 152 of the Case Homepage 112, according to an embodiment of the invention. In this example, the “quick profile” of each custodian includes the custodian's name, an employee ID (if applicable), job title, an email address, a work phone number and an associated custodian priority indication. The custodian priority indication is represented by a Tier, where Tier 1 indicates a higher priority than Tier 2. The Custodians List page 114 is the default page view that is also displayed upon selection of the custodians link 156 of the Documents and Lists page of FIG. 7 below.

A quick launch panel link 151 displays custodian related links to enable a user 11 to easily view aspects of custodian information such as preservation notice status, interview status, etc. In this case, the Custodians List page 114 is a customized filtered view page that includes custodians and selected associated information; a pared-down version of each custodian's larger profile. The fields and layout in a customized filtered view are easily established by the portal administrative user using the Modify Columns and Settings link available from any list or document library page of the portal 100. For example, when an Import Custodians link 176 is selected, the portal server 16 causes an Import Custodians page to be displayed to allow the user 11 to import custodians into the case. After importation, the list of imported custodians is displayed on a number pages of the web portal 100.

FIG. 9 is a screen shot of an exemplary Import Custodians page 116 that may be displayed to the user 11 upon selecting the Import Custodians link 176 from the Custodians List page 114 of FIG. 8, according to an embodiment of the invention. The Import Custodians page 116 includes an Imported People pane 166, a Case Custodians pane 163, an Import People search query window 165, a Case Custodians search query window 167. An Import to Custodian button 170 and a Re-Sync Custodian List button 171 are also displayed on the Import Custodians page 116.

The Imported People pane 166 is configured to display a list 173 of personnel imported from an organization(s) where the list includes potential custodians. The list 173 is derived from personnel information provided by, for example, the organization's human resources (HR) department from its in-house HR database tool (e.g., PeopleSoft, SAP). Such personnel information may be transferred by any number of means such as, for example, an Excel spreadsheet stored on a CD, a file transfer protocol (FTP), etc., to an import tool of the portal network 14. Once the data elements of the import file have been mapped to the SQL server 20 via the import tool, an automated process of the portal server 16 imports the custodian data to make it available for users 11 inside the Imported People pane 166. The custodian names and associated other personnel data may then be displayed to the user 11 via a portal web page such as the Import Custodian page 116.

In some instances where a large corporation is hosting the portal network 14 in-house, the personnel information may be transferred directly from their in-house HR database tool to the Imported People pane 166. Each personnel entry displayed in the Imported People pane 166 is associated with a check-box 175, a personnel ID number 177 and an email address 179.

The Case Custodians pane 163 is configured to display the names of case custodians selected from the Imported People pane 166. Case custodians that are “moved” from the Imported People pane 166 to the Case Custodian pane 163 are key personnel who have been determined to have potentially discoverable information for that case, and therefore must be notified to hold or preserve that discoverable information. In most instances, the number of case custodians identified in the Case Custodians pane 163 is far less than the number of names appearing in the Imported People pane 166.

The case custodians displayed in the Case Custodians pane 163 are selected by placing a check-mark in the check-box 175 next to the respective name 173, followed by user selection of an Import to Custodian button 181. Other case custodian selection methods such as manual entry of case custodians are also contemplated. In addition, in large litigations, information displayed in the Imported People pane 166 for one case (e.g., Gibson v Kipler) may be identical to information displayed in an Imported People pane of another case (e.g., Palmer Products v. Kipler).

In some instances it may be necessary to search for a person in the Imported People pane 166 in order to select that person as a case custodian. To preclude manual scrolling up and down through the imported people entries, the Import Custodians page 116 includes the Import People search query window 165. Entry of a person's first or last name or personnel number followed by selection of a Search button 169 causes all custodians matching the entry to be displayed in the Imported People pane 166. The Case Custodians search query window 167 and a Search button 183 enables the user 11 search for a particular case custodian. Other search methods such as alphabet paginating or numerical paginating are contemplated. User selection of the Re-Sync Custodian List button 171 causes updated custodian information (e.g., new last name via marriage) to be imported to the Imported People pane 166.

Once identified, custodians are notified to preserve discoverable information regarding one or more cases through a series of emails and acknowledgments, according to an embodiment of the invention. The notifications, acknowledgements, associated time stamps and other preservation notice information is tracked and may be viewed by the user 11 as discussed below. For ease of discussion, preserving and tracking such information is referred to herein as a preservation notice feature of the portal 100.

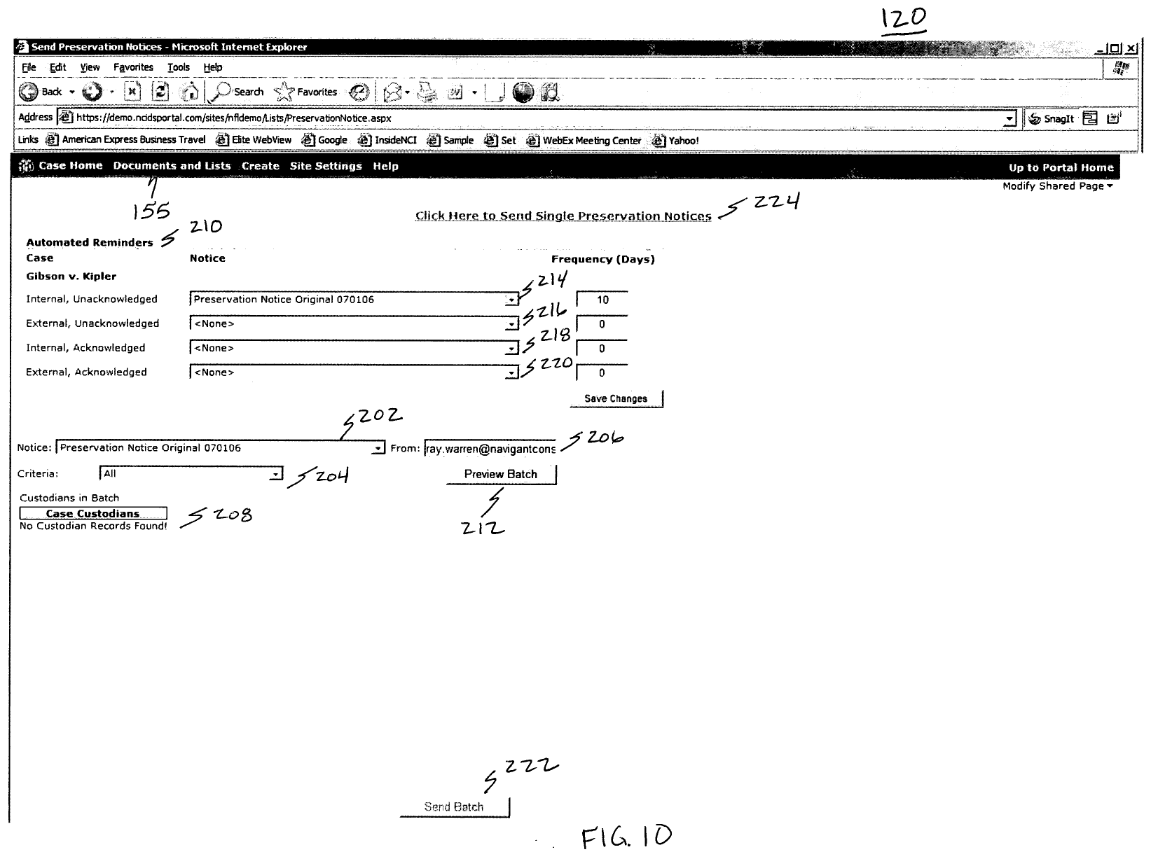

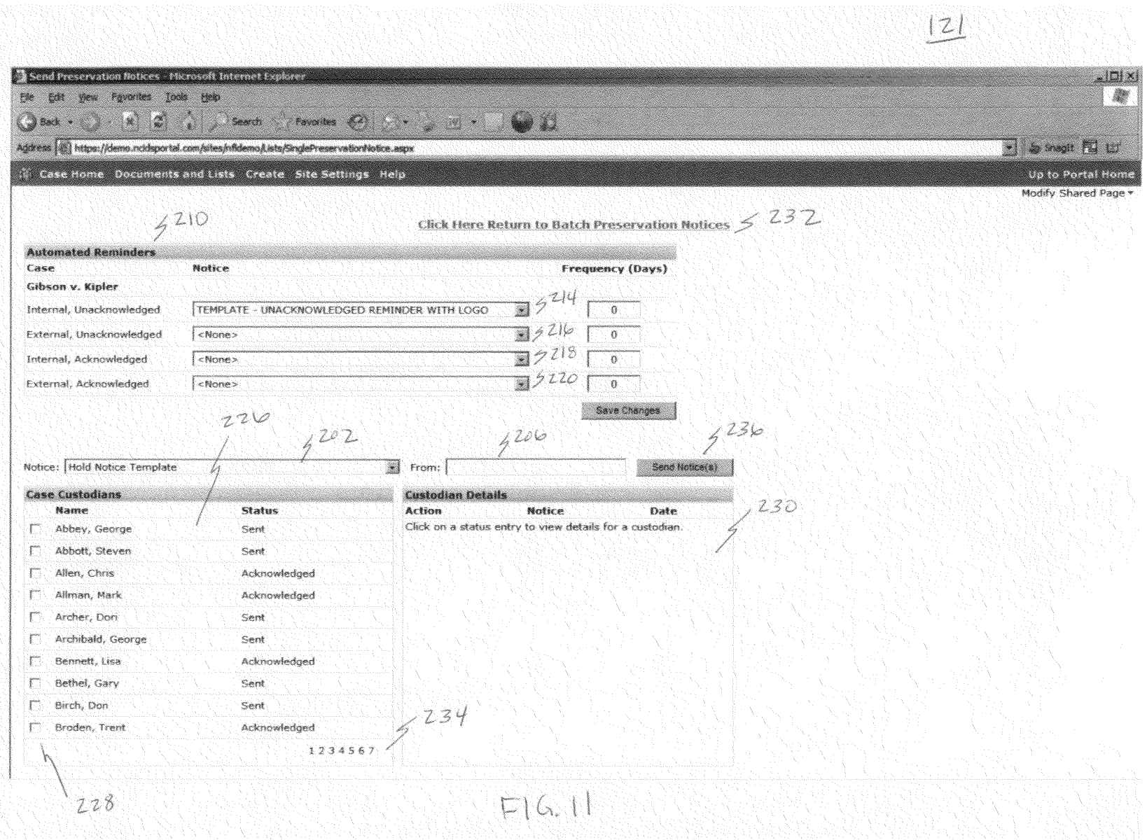

The preservation notice feature of the portal 100 enables the user 11 to easily create and manage preservation notices and their associated acknowledgements. The preservation notice feature of the portal 100 also enables automatic sending and tracking of preservation notices and their associated acknowledgements to a large group (batch) of custodians (see, FIG. 10) or to individually selected custodians (see, FIG. 11).

FIG. 10 is a screen shot of an exemplary Batch Send Preservation Notice page 120 that may be displayed to the user 11 upon selecting a Send Preservation Notice link 180 from one of the Custodians pages (e.g., the Custodians List page of FIG. 8), according to an embodiment of the invention. Unlike prior art methods, the Batch Send Preservation Notice page 120 enables the user 11 to easily send preservation notices and associated reminders to an unlimited number of case custodians, either internal or external, without the aggravation of individually selecting each custodian from a list of custodians that may number in the thousands.

For ease of discussion, the term “internal” with respect to case custodians, is defined herein to refer custodians internal to the associated company or organization (e.g., a direct employee), while the term “external” is defined herein to refer to custodians external to, but with an affiliation to, the associated company or organization. For example, an ex-CEO of the associated company or organization may currently work as a contractor for them and may possess discoverable information in her laptop. In that instance, her custodian information may have been manually entered via selection of an Edit in Datasheet icon 187 displayed in a toolbar of the Custodians List page of FIG. 8.

Referring to FIG. 10, included are a Notice drop-down menu 202, a Criteria drop-down menu 204, a From window 206, and a Case Custodians view area 208. The Notice drop-down menu 202 and the From window 206 enable the user 11 to select a preservation notice and send it to a set of custodians determined by the Criteria drop-down menu 204 selection.

The Notice drop-down menu 202 enables the user 11 to select which one of a number of versions of preservation notices or templates associated with the case are to be sent. Although a ‘Preservation Notice Original 070106’ has been selected, the Notice drop-down menu 218 may additionally include multiple preservation notice templates and/or multiple versions of a ‘Preservation Notice Change’. Multiple versions of the preserve notices may be the result of, for example, receipt of an amended complaint in a product liability suit, filed after the first preservation notices were sent.

The Criteria drop-down menu 204 is configured to enable the user 11 to select the criteria to describe which custodians are to receive the preservation notices. For example, the criteria may include all of the case custodians, as would be applicable for a new litigation. The criteria may also include all custodians who have not yet received preservation notices (e.g., unsent preservation notices), all custodians who have not acknowledged receipt of a preservation notice (e.g., all unacknowledged preservation notices), internal only custodians who have not yet received preservation notices (e.g., unsent internal only), internal only custodians who have not acknowledged receipt of a preservation notice (e.g., unacknowledged internal only), external custodians who have not yet received preservation notices (e.g., unsent external only) and external only custodians who have not acknowledged receipt of a preservation notice (e.g., unacknowledged external only). In any event, it is not required that the user 11 select, custodian by custodian, who is to receive the preservation notice.

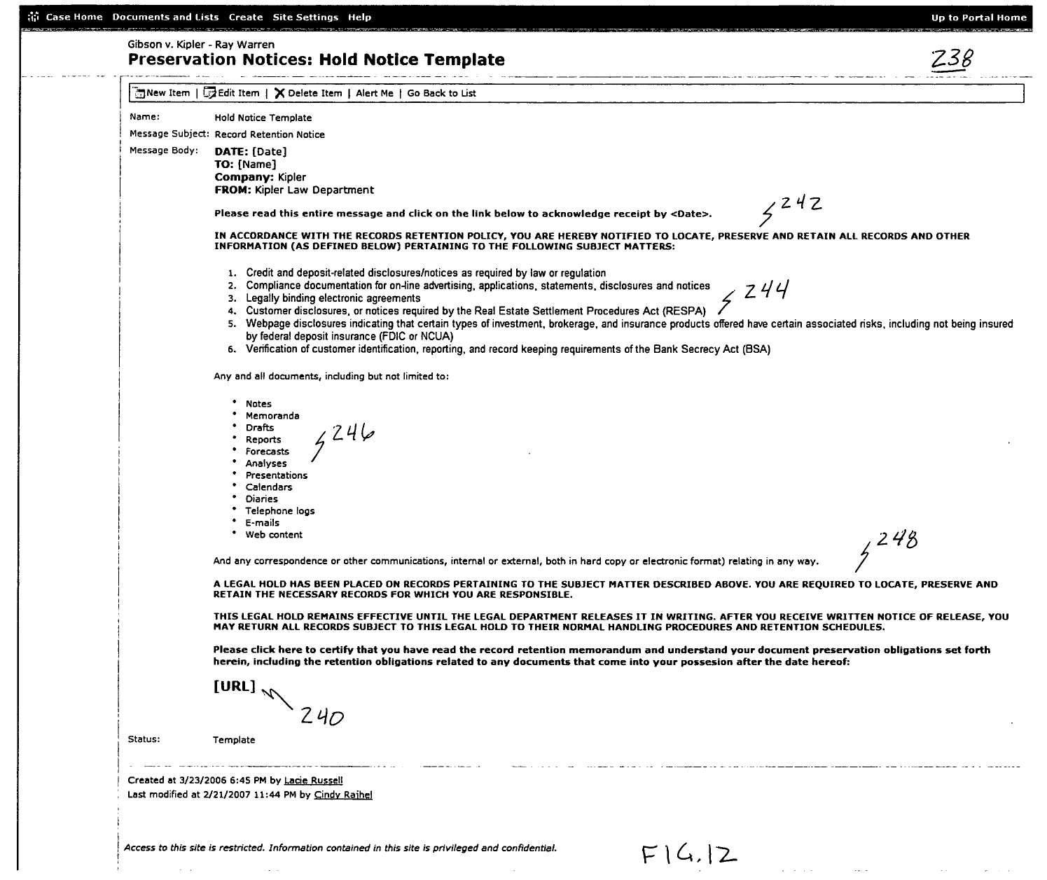

Further, selection of a Preview Batch button 212 causes a list of custodians fitting the criteria displayed in the Criteria drop-down menu 204, to be displayed to the user 11 via the Case Custodians view area 208. After user 11 selection of the notice version and the criteria, and entry of the sender's name, user 11 selection of the Send Batch button 222 causes the associated preservation notice template to be populated and sent to the designated custodians. As will be described in connection with FIG. 12, a preservation notice email template is automatically populated by the portal server 16, before sending, with a date and a preservation acknowledgement URL and a senders name as it appears in the From window 206.

After an initial round of preservation notices is sent to the custodians, some custodians will acknowledge receipt of the preservation notice immediately, while others will delay. For those custodians who delay their acknowledgement too long, reminders can be sent using an Automatic Reminder section 210 of the Batch Send Preservation Notice page 120. The Automatic Reminder section 210 of the Batch Send Preservation Notice page 120 includes four drop-down menus associated with the case, where each of the four types of reminders has a frequency-to-remind (in days) selection text box. Referring to FIG. 10, an Internal Unacknowledged drop-down menu 214 enables the user 11 to select one of possibly a number of versions of preservation notices (e.g., the most recently sent preservation notice) associated with the Gibson v. Kipler case to be automatically sent to internal custodians who have not acknowledged receipt of the previous preservation notice, at a frequency entered in an associated frequency text box. For example, a preservation notice may be sent every 10 days to all internal custodians who have not acknowledged receipt of the preservation notice entitled “Preservation Notice Original 070106”. Likewise, an External Unacknowledged drop-down menu 216 enables the user 11 select one of the number of versions of preservation notices associated with the case to be automatically sent to external custodians who have not acknowledged receipt of the previous preservation notice, at a frequency entered in the associated frequency text box.

Similarly, an Internal Acknowledged drop-down menu 218 enables the user 11 select one of the number of versions of preservation notices associated with the case to be automatically sent to internal custodians who have acknowledged receipt of the previous preservation notice, at a frequency entered in an associated frequency text box, and an External Acknowledged drop-down menu 220 enables the user 11 select one of the number of versions of preservation notices or templates associated with the case to be automatically sent to external custodians who have acknowledged receipt of the previous preservation notice, at a frequency entered in an associated frequency text box.

In a case where it is desirable to send preservation notices to a single custodian or to a small group of custodians, selection of a “Click Here to Send Single Preservation Notices” link 224 of FIG. 10 causes an alphabetically-ordered Case Custodian list 226 to be displayed as shown in FIG. 11. A preservation notice status (e.g., sent, acknowledged) is displayed next to each of the custodians listed in the Case Custodian list 226. Check-boxes 228 are also displayed next to each custodian to enable the user 11 to select one or more custodians for receipt of a preservation notice.

Concurrent with displaying the Case Custodian list 226, the portal server 16 causes a Custodian Details status window 230 and a “Click Here to Return to Batch Preservation Notices” link 232 to be displayed. The Custodian Details status window 230 displays associated preservation history information for selected custodians, and the Click Here to Return to Batch Preservation Notices link 232 enables the user 11 to return to the Batch Send Preservation Notice page 120. Numerical pagination 234 is displayed below the Case Custodians list 226 to enable the user 11 to easily search for a particular custodian. As noted above, the Notice drop-down menu 202 enables the user 11 to select which of a number of preservation notices are to be sent to the custodians; in this case, which of the number of preservation notices are to be sent to a selected number of custodians indicated via an associated Check-box 228. A “Send Notices” button 236 enables the user 11 to cause the portal server 16 to send the preservation notices to the selected custodians.

A preservation notice may be sent to a custodian as an email or as an attachment to an email, etc. FIG. 12 is a screen shot of an exemplary Preservation Notice Email template 238, including an embedded Acknowledgement link 240 that may be sent to a custodian, according to an embodiment of the invention. In the illustrated example, the Preservation Notice Email template 238 may be accessed via a selection from the Documents and List page of FIG. 7.

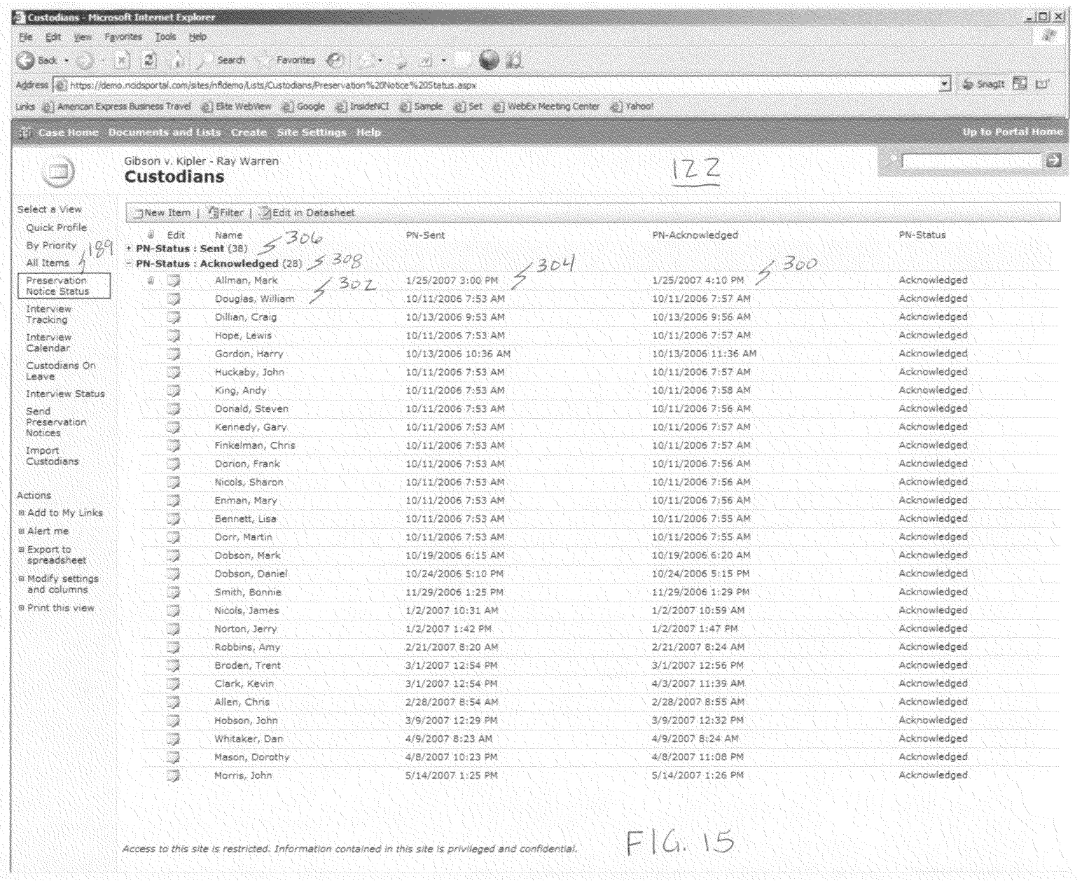

In addition to general information 242, the Preservation Notice Email template 238 includes a list of items to be preserved 244, a list of documents to be preserved 246, and a legal hold instruction 248. The Preservation Notice Email template 238 also includes the Acknowledgement link 240, which when selected by the custodian, automatically causes an acknowledgement, indicating receipt of the preservation notice by the custodian, to be returned to the URL (associated with the portal server 16). When received, the acknowledgement is displayed in a number of views and lists for tracking purposes, for example, in a PN acknowledgement timestamp identity column 300 of FIG. 15.

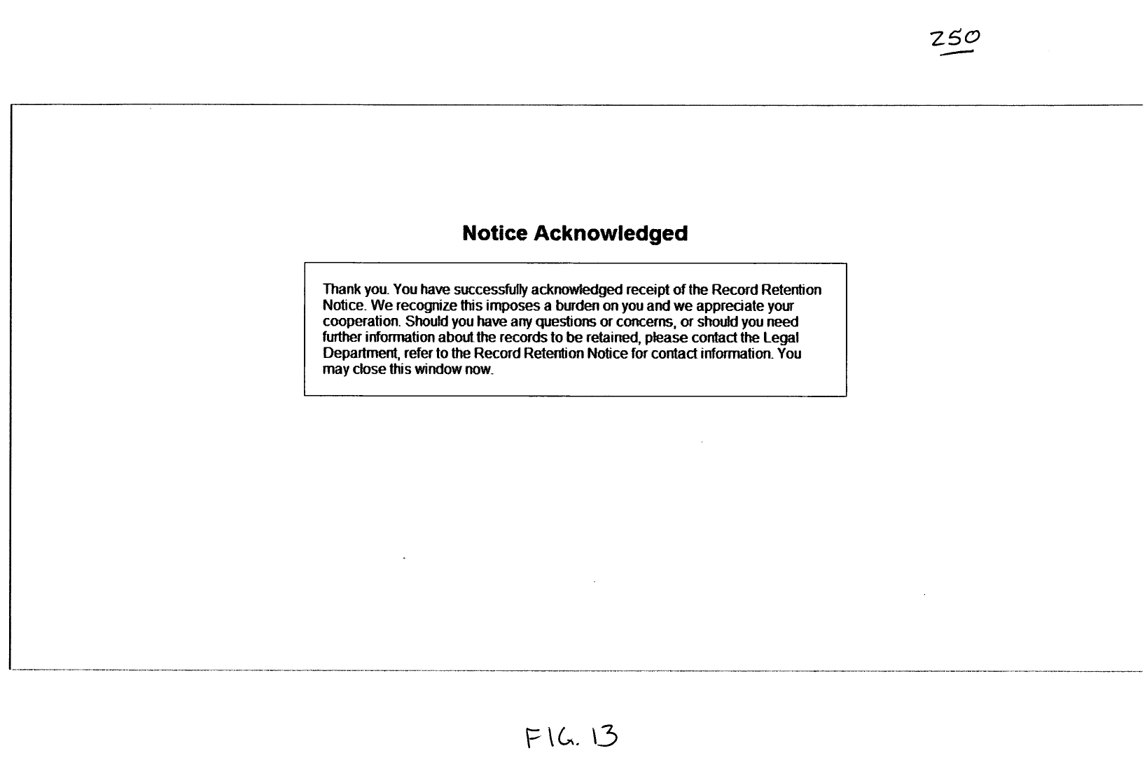

In addition, a Notice Acknowledged indication is displayed to the custodian when he/she selects the Acknowledgement link 240. FIG. 13 is a screen shot of an exemplary Notice Acknowledged indication 250 that may be displayed to a custodian who has acknowledged receipt of his/her preservation notice email, according to an embodiment of the invention.

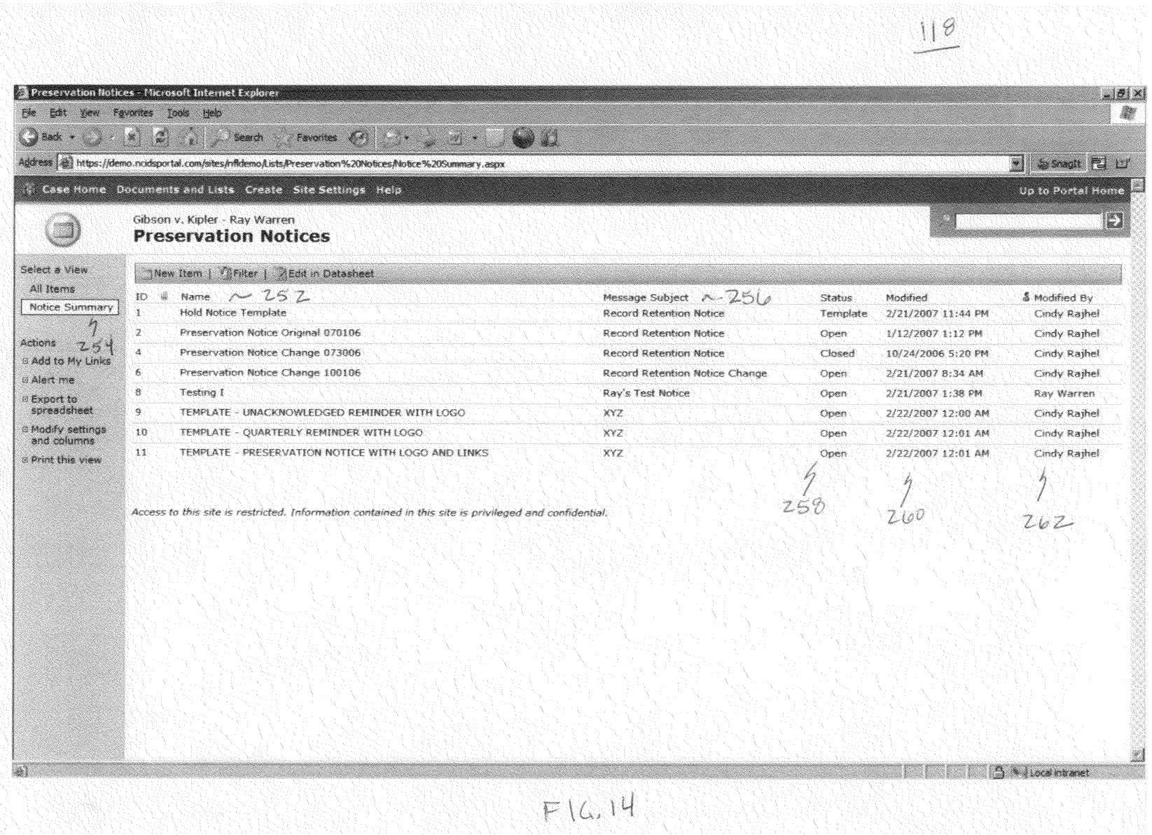

FIG. 14 is a screen shot of an exemplary Preservation Notice Summary page 118 that may be displayed to the user 11 upon selecting a Preservation Notices link 251 from the Documents and List page 113, according to an embodiment of the invention. In the illustrated example, the user 11 selected a Notice Summary view 254 to display a summary of preservation notices and templates associated with the case.

Referring to FIG. 14, the items listed in a Name list 252 are derived from the items listed in the Notice drop-down menu 202 of FIG. 10, 11. For each entry, the summary includes the name given to the preservation notice or template, a entry subject or purpose indicated by a Message Subject entry 256, a status of the entry indicated by a Status 258, a Date Modified entry 260 and a Modified By entry 262 listing the name of the person performing the modification of the entry.

In addition to providing the robust preservation notice feature discussed throughout, the portal server 16 is configured to manage and track custodian information, interviews, media shipments, filtering status, reviews and productions. As described above, the portal server 16 is configured to automatically track the date(s) and time(s) of preservation notice delivery and preservation notice acknowledgements.

FIG. 15 is a screen shot of another exemplary Custodians page 122 that may be displayed to the user 11 upon selecting a Custodians link 156 from the Documents and List page 113 or the Custodian List page 114 of FIG. 8, according to an embodiment of the invention. In the example of FIG. 15, the user 11 selected a Preservation Notice Status view 189. As illustrated, for each custodian of the Gibson v. Kipler case, the Custodians page 122 provides a preservation notice status and a preservation notice acknowledgements status.

The preservation notices status view of the Custodians page 122 includes a Names column 302 that displays the custodian names to whom a preservation notice has been sent, an associated PN sent timestamp identity column 304 and the PN acknowledgement timestamp identity column 300. Preservation notice sent counts 306 and preservation notice acknowledgement counts 308 are also displayed. In the illustrated example of FIG. 15, thirty-eight preservation notices were sent to thirty-eight custodians, and twenty-eight were acknowledged.

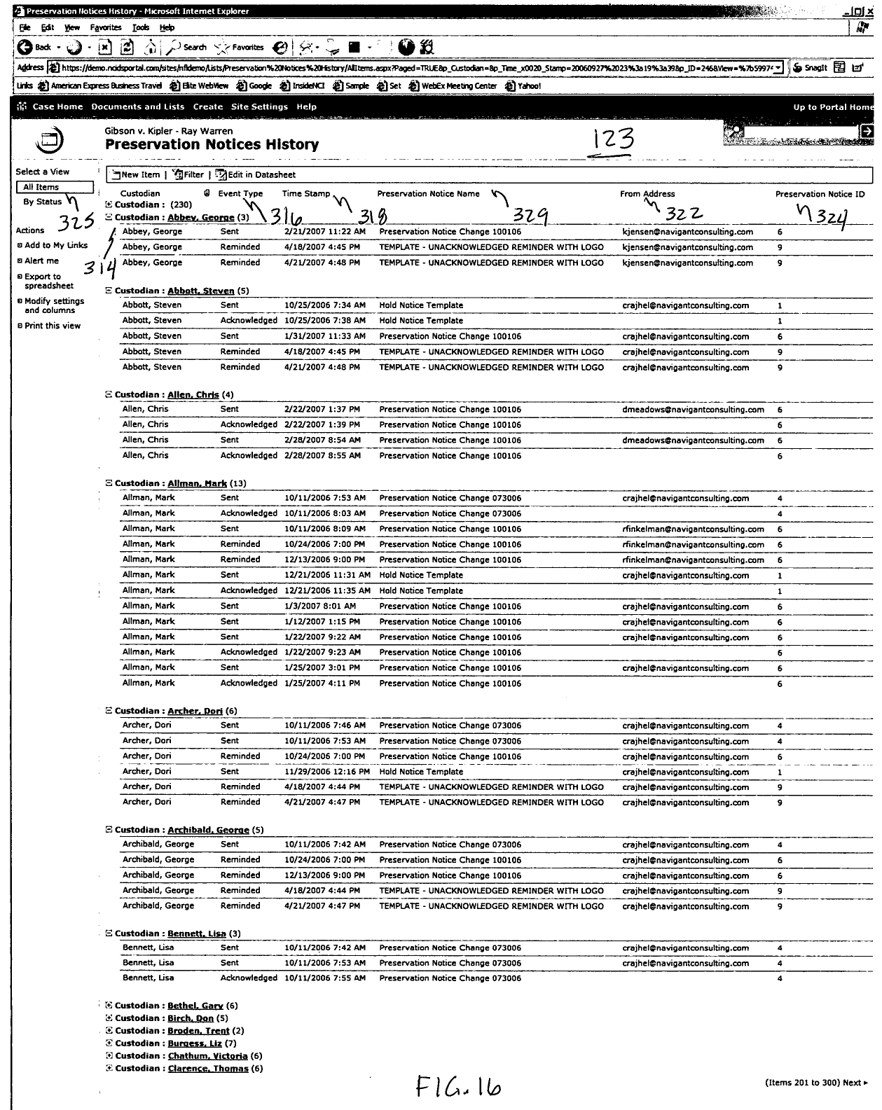

FIG. 16 is a screen shot of an exemplary Preservation Notices History page 123 that may be displayed to the user 11 upon selecting a Preservation Notices History link 310 from the Documents and List page of FIG. 7, according to an embodiment of the invention. In the example of FIG. 16, the user 11 selected an All Items view 325. Unlike prior art methods, use of the Preservation Notice History page 123 and its associated functionality precludes a need for cumbersome spread sheets (e.g., Excel) or manual tracking of preservation notices.

Referring to FIG. 16, an alphabetically ordered list of the custodian names 314 are provided on the left-hand side of the screen shot (not viewable in screen shot). Each custodian name may appear multiple times in the list 314 where multiple preservation notice activity has occurred. Multiple preservation notice activity is listed sequentially in time, however other configurations are possible. Each preservation notice activity includes an Event Type entry 316 (e.g., sent, reminded, acknowledged), a Time Stamp entry 318 of a time the associated event type occurred, a Preservation Notice Name entry 320 which corresponds to one of the entries (e.g., an entry in the Notice drop-down menu 202) accessible via the Batch Send Preservation Notice page of FIG. 10, or the Send Single Preservation Notice page of FIG. 11. The Preservation Notices History page 123 also includes a From Address entry 322 indicating a source of the preservation notice email and a preservation Notice ID entry 324.

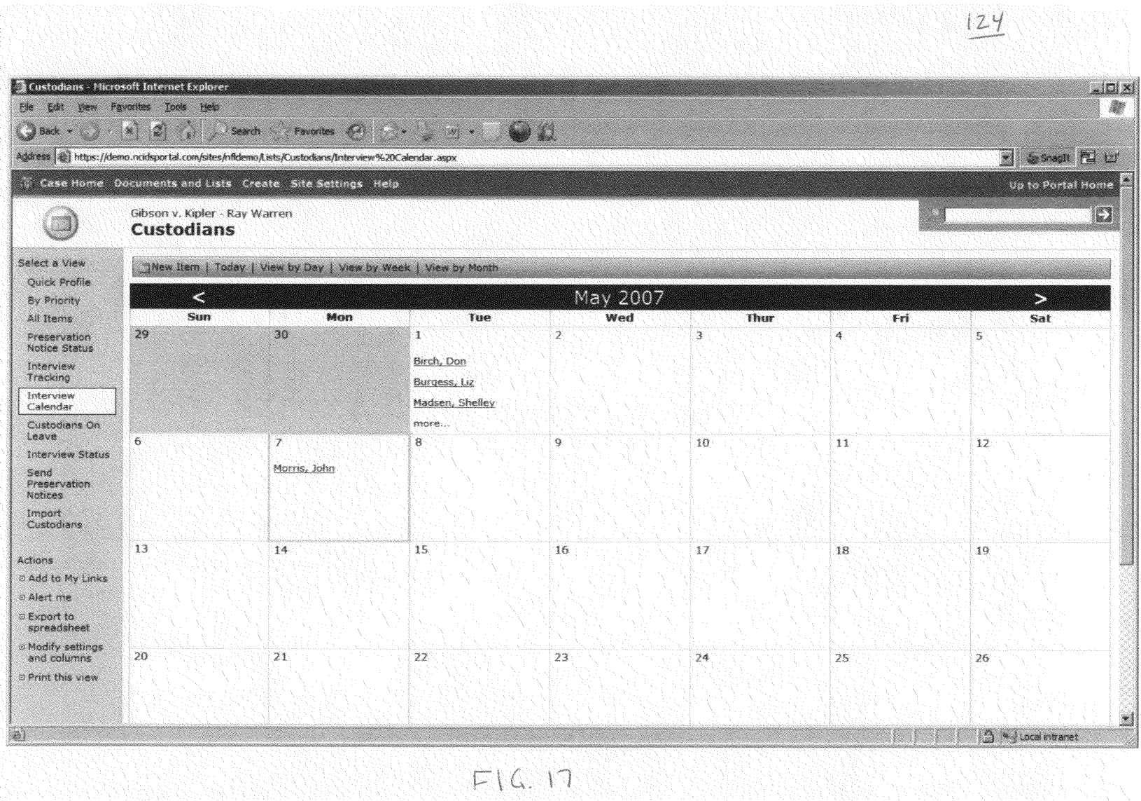

FIG. 17 is a screen shot of an exemplary Custodian Interview Calendar page 124 that may be displayed to the user 11 upon selecting a Interview Calendar link 324 from the Custodians Quick Profile page 114 of FIG. 8, according to an embodiment of the invention. Each custodian to be interviewed for a particular case (e.g., Gibson v. Kipler) is listed in the interview calendar 124. Clicking on or selecting a particular custodian name from the calendar causes additional details such as contact information to be displayed.

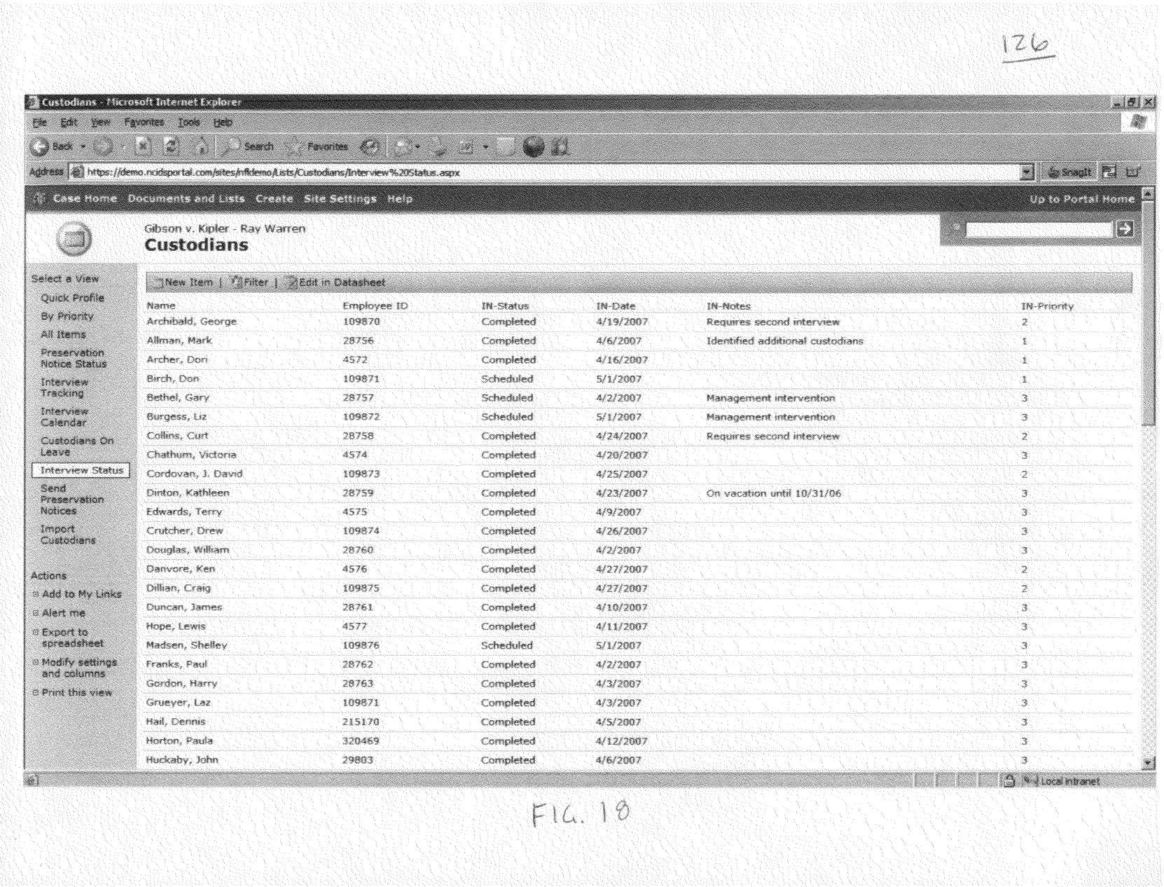

An interview library of the web portal 100 includes interview forms, questionnaires and completed interviews. FIG. 18 is a screen shot of an exemplary Custodian Interview Status page 126 that may be displayed to the user 11 upon selecting an Interview Status link 326 from the Custodians Quick Profile page 114 of FIG. 8, according to an embodiment of the invention. When selected, the Custodian Interview Status page 126 displays an interview status and interview date associated with each custodian. For example, custodian Archibald has completed his interview, while custodian Birch has not.

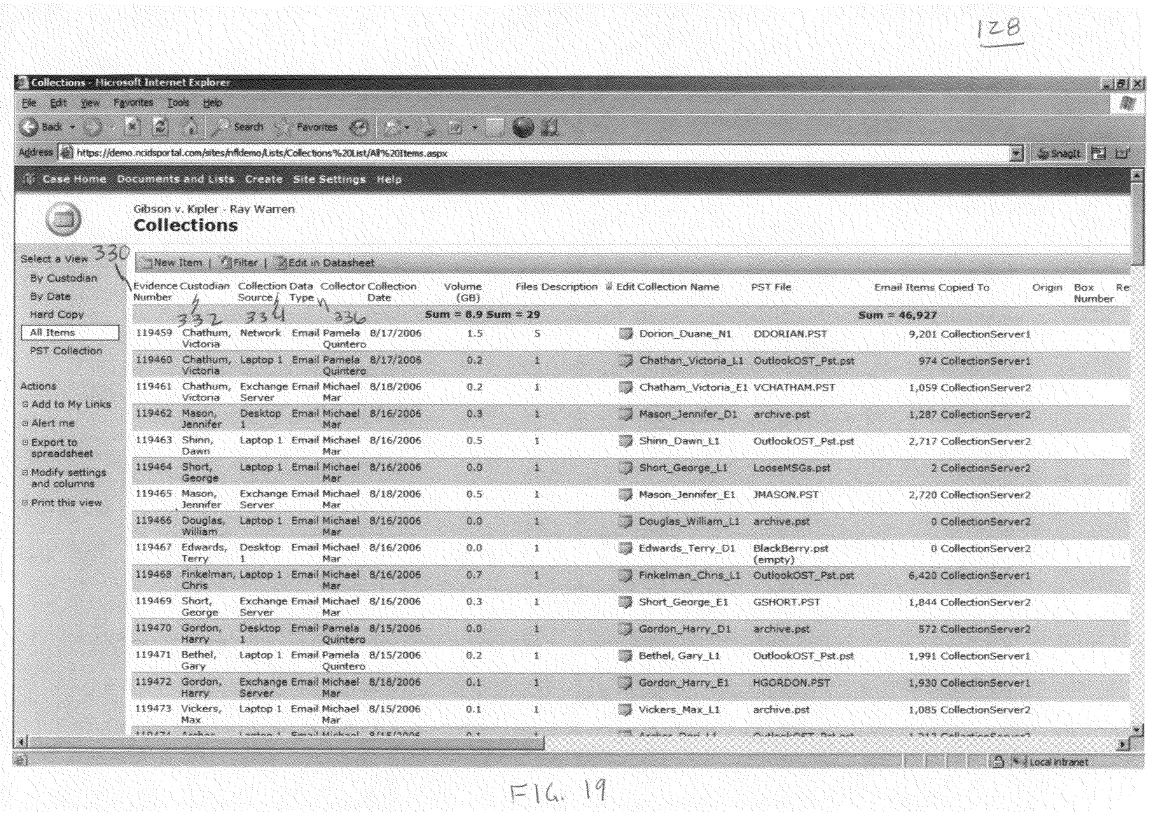

FIG. 19 is a screen shot of an exemplary Track Collections page 128 that may be displayed to the user 11 upon selecting a Collections link 158 from the Docs and Lists page 113 of FIG. 7, according to an embodiment of the invention. The term ‘collections’ refers to the discoverable information collected from the listed custodians. For each item of discoverable information collected, the Track Collections page, displays, inter alia an evidence number 330, a custodian name 332, a collection source 334, a date type 336. Multiple collections are tracked for each custodian so, where one custodian has provided more that one items, each item has its own entry.

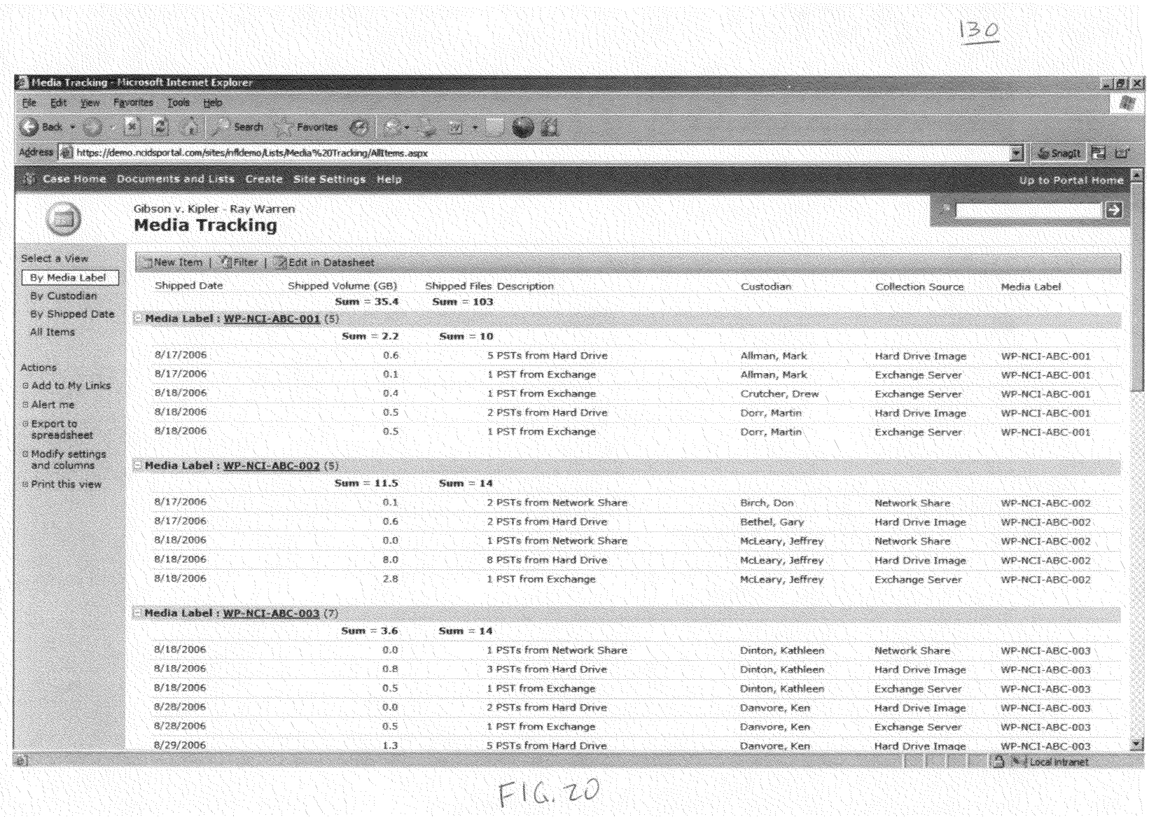

FIG. 20 is an exemplary screen shot of a Media Tracking page 130 that may be displayed to the user 11 upon selecting a Media Tracking link 159 from either the Case Homepage 112 or the Documents and Lists page 113, according to an embodiment of the invention. The Media Tracking page 130 displays the information need to track the storage media used to transfer potentially discoverable information collected from custodians to a processing entity such as a processing vendor (see, FIG. 3). As illustrated, chain of custody of the discoverable information is also tracked via the web portal 100. As a result, the Media Tracking page 130 may serve as a record suitable for a regulatory body or requesting party if the integrity of the collected data was ever questioned. The processing entity generates “processed information” which is then searched or reviewed using agreed-upon filter terms or other key search terms.

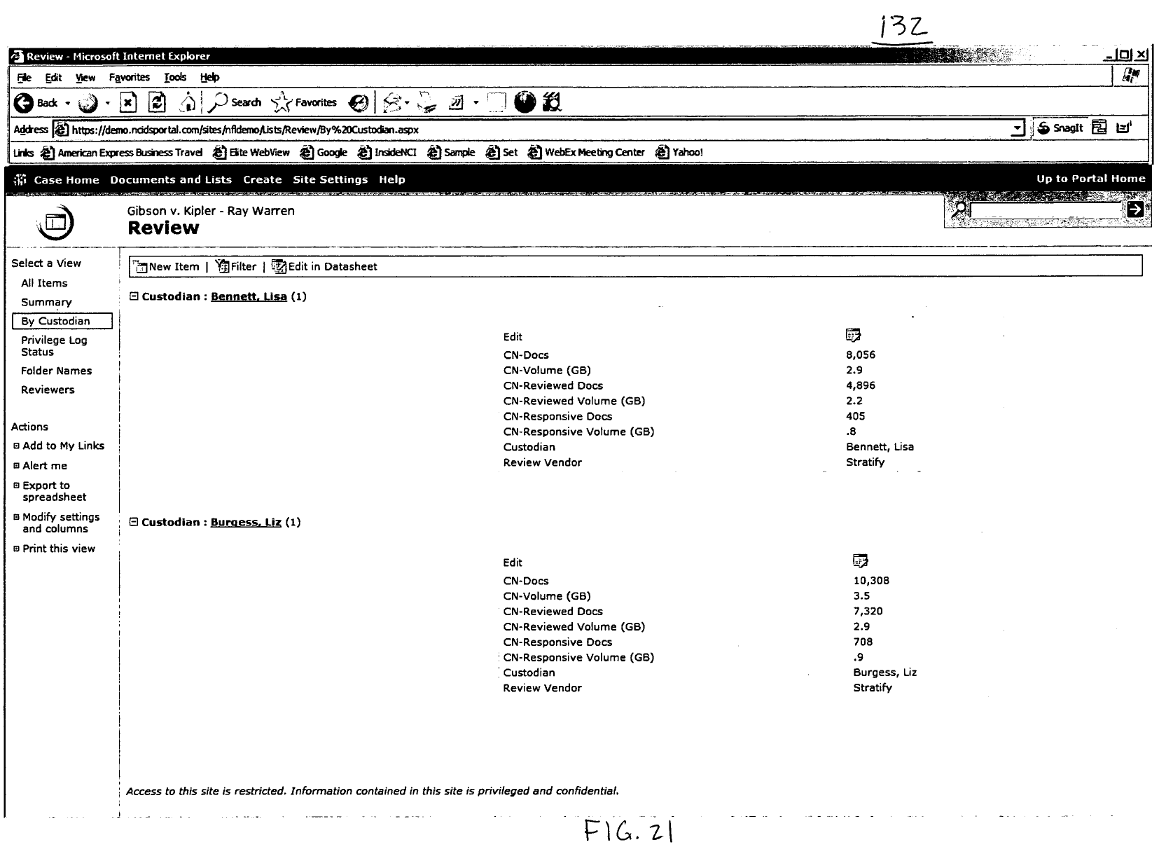

FIG. 21 is a screen shot of an exemplary Review Status page 132 that may be displayed to the user upon selecting a Review link 153 from the Case Homepage 112 or the Documents and Lists page 113, according to an embodiment of the invention. As used herein the term. “review” refers to the act of reviewing the processed information by qualified personnel for purposes of determining whether the processed information is useful. As illustrated, the Review Status page 132 displays the number of documents to be reviewed, the number of documents that have been reviewed, the number of documents which have been deemed useful or responsive, and so on.

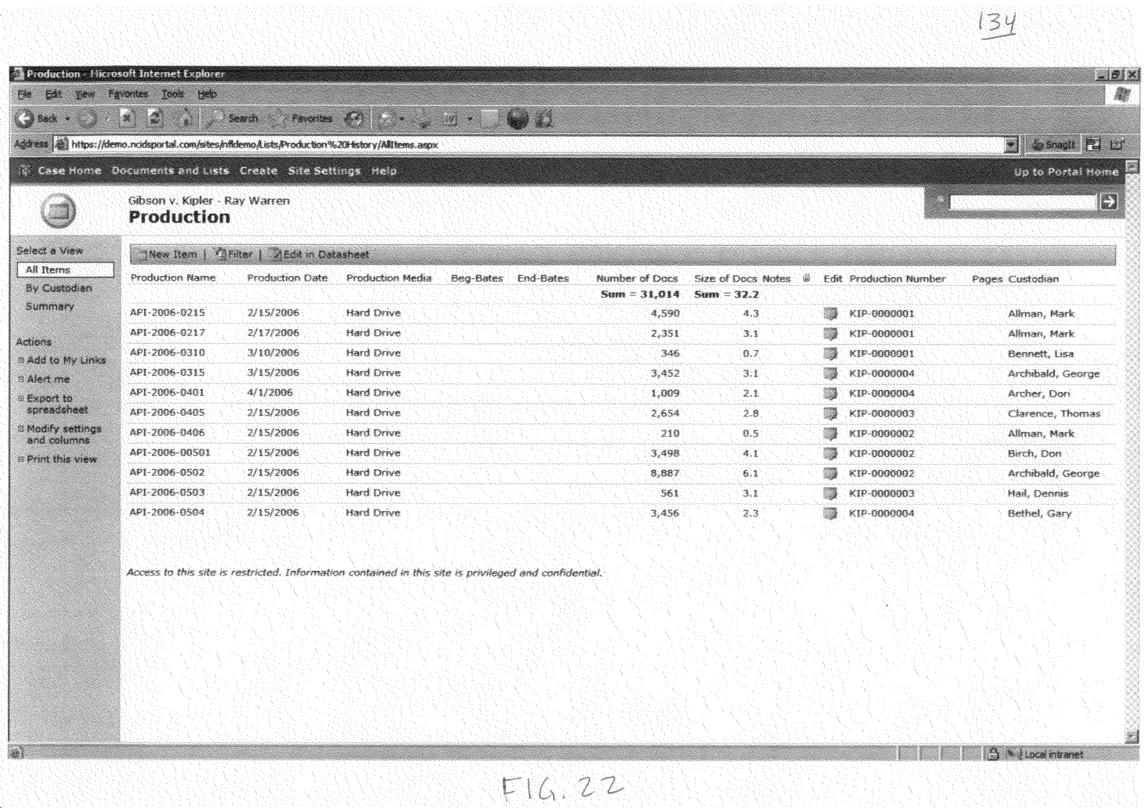

FIG. 22 is a screen shot of an exemplary Production Summary page 134 that may be displayed to the user upon selection of the Production link 157 from the Case Homepage 112 or the Documents and Lists page 113, according to an embodiment of the invention. As used herein, the term “production” refers to the process of providing the information that is relevant in the case to the requesting party. Accordingly, the information and data that has passed through collection, processing, reviewing and is produced. As illustrated, production may be sorted by date, batch or custodian.

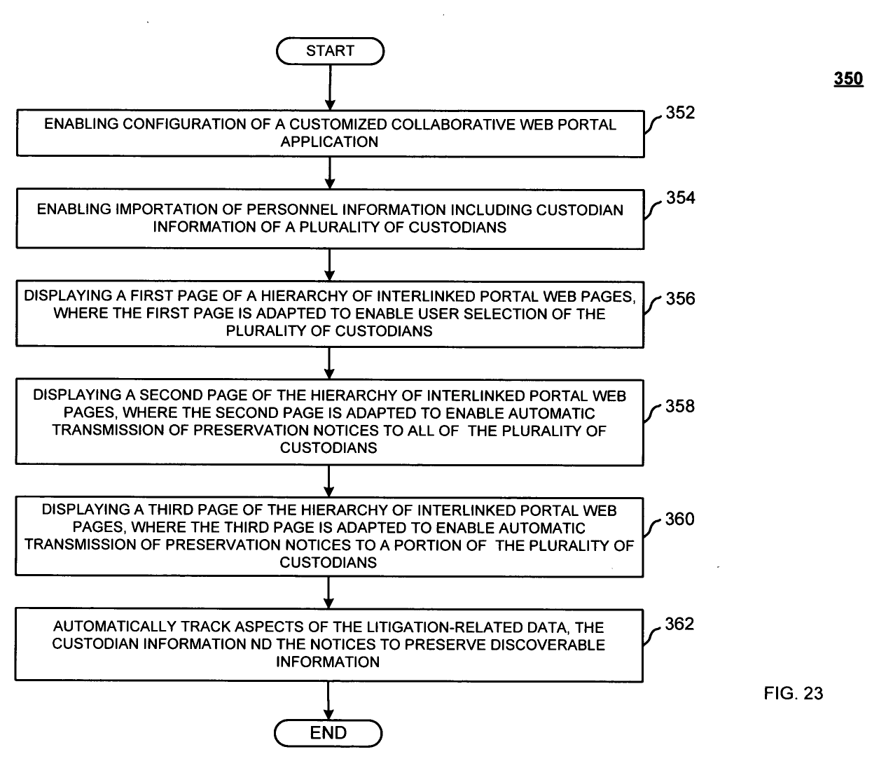

FIG. 23 is a flow chart of a method for providing the web portal of FIG. 1, according to an embodiment of the invention.

Details of the preservation notice feature of the portal 100 are as follows:

As is known, when companies place legal holds on potentially responsive records they must also be prepared to prove to the courts that they used reasonable efforts to ensure that those legal hold orders are followed. The preservation notice feature of the portal 100 streamlines this legal hold, or preservation process, by creating, managing, sending and tracking preservation notices inside one case. In general, the preservation notices are sent electronically via email to custodians required to preserve discoverable information. The body of the email contains the preservation instructions as described above (see, FIG. 12). The recipient/custodian of the preservation notice reads the email and clicks an indicated link in the email to acknowledge receipt (see, FIG. 13). The date and time of delivery and acknowledgment is automatically updated in real-time inside each case site and displayed on associated portal web pages (see, FIG. 15).

Functionality of the preservation notice feature of the portal 100 may be grouped into three categories: 1) creating and managing preservation notices, 2) populating custodian lists, and 3) sending and tracking preservation notices.

(1) Creating and Managing Preservation Notices

Creating preservation notices: Preservation notices are stored in a Preservation Notices list at the data storage 22 (or the SQL server 20). Users 11 may create and update preservation notices using Microsoft Word and paste the text into the rich text screen inside a case, or type the notices directly into the rich text screen (see, FIG. 12).

Attachments: One or more documents can be attached to the preservation notice email. The documents may be stored in a portal document library and then attached to the preservation notice at the time of sending. Other storage options are possible.

Managing preservation notices: Preservation notices are stored at the case level (see, FIG. 6 for case page). Each preservation notice is automatically assigned an identification number by the portal server 16 (see, FIG. 16). Preservation notices can be foldered by case, type or date and sorted by type, date, filename and identification number. Other options for sorting and managing notices are configurable.

(2) Populating Custodian Lists from HR System Data

Importing from HR Systems: A nightly scheduled process imports names/profiles of users and/or custodians from a designed people import file from an HR system (not separately illustrated) into the data storage 22. The number of names/profiles imported may include a limited number of profiles or may include all of the profiles. By conducting a selective “import” to the data storage 22 (or the SQL server 20), users 11 are not required to sort through long lists.

The user and/or custodian profiles imported into the profile database may be individually selected or selected in multiples to populate the custodian lists for each case. A “Custodian Import” component displays profiles that have already been imported to the profile database and allows them to be added as custodians to a case (see, FIG. 9). Additionally, custodians that are not in the people import file can be manually added through other web pages of the portal 100. Users 11 can also select a custodian in the custodian list to view details associated the custodian's entry (see, FIG. 6).

Synchronizing with the People Import File: A manual refresh-feature synchronizes contacts and over-writes the information in the custodian list with the latest people import file (see, FIG. 6). Custodians that do not exist in the import file are left untouched. This allows administrative users to import and synchronize user profiles into the custodian lists at the case level.

(3) Sending and Tracking Preservation Notices

Sending: Preservation notices may be sent to all custodians (see, FIG. 10) or to a select group of custodians (see, FIG. 11). The custodian list is the source from which the user 11 will pick who to send preservation notices. The custodian list can be populated several ways. Name and profiles can be imported from the people import file originating from an HR database. They can also be imported from a spreadsheet, or input manually into the list. Users 11 can choose which custodians will receive notices, and can choose the appropriate notice to deliver to those custodians. A send preservation notices screen configured to enable preservation notices to be sent allows the user 11 to choose all identified recipients or those persons that have not yet been sent a notice or have not acknowledged.

All documents that were attached to an associated preservation notice will be noted as attachments to that preservation notice line entry.

If an email address for the custodian is undeliverable, the (sender) user 11 will receive a delivery failure report in his/her email inbox. If the (recipient) custodian has enabled their Out of Office Agent, the sent date and timestamp is recorded in the preservation notice status.

Track Notices: All preservation notices sent for all sites are listed and can be sorted by custodian, notice name, and date. Sent and acknowledged dates are tracked every time a preservation notice is sent and acknowledged. A list logs each event (see, FIGS. 15 and 16). The log includes the custodian name, case, notice name, and event (sent, reminder, or acknowledged) types. Views of this information can be sorted by Custodian, Sent Date and by Acknowledged Date. In addition, the original preservation notice is archived as part of a history log to ensure an unaltered version of the preservation notice is retained.

Automatic Preservation Notice Reminders: Users 11 may send automatic reminders and set the frequency (number of days) for delivery. On a per case basis, the reminder emails can be sent to all custodians who have not acknowledged the most recent preservation notice. The word “Reminder” is automatically populated into the subject line of the reminder email. Attachments may also be included. Users can select the version of the notice that will be sent when configuring reminders.

The present method may be implemented as a computer process, a computing system or as an article of manufacture such as a computer program product or computer readable medium. The computer program product may be a computer storage media readable by a computer system and encoding a computer program of instructions for executing a computer process. The computer program product may also be a propagated signal on a carrier readable by a computing system and encoding a computer program of instructions for executing a computer process.

In one embodiment, the logical operations of the present method are implemented (1) as a sequence of computer implemented acts or program modules running on a computing system and/or (2) as interconnected machine logic circuits or circuit modules within the computing system. The implementation is a matter of choice dependent on the performance requirements of the computing system implementing the invention. Accordingly, the logical operations making up the embodiments of the present invention described herein are referred to variously as operations, structural devices, acts or modules. It will be recognized by persons skilled in the art that these operations, structural devices, acts and modules may be implemented in software, in firmware, in special purpose digital logic, and any combination thereof without deviating from the spirit and scope of the present invention as recited within the claims attached hereto.

While this invention has been described with reference to certain illustrative aspects, it will be understood that this description shall not be construed in a limiting sense. Rather, various changes and modifications can be made to the illustrative embodiments without departing from the true spirit, central characteristics and scope of the invention, including those combinations of features that are individually disclosed or claimed herein. Furthermore, it will be appreciated that any such changes and modifications will be recognized by those skilled in the art as an equivalent to one or more elements of the following claims, and shall be covered by such claims to the fullest extent permitted by law.

What is claimed is:

1. A system for providing a web portal for managing litigation activities, the system comprising:
a portal computing device including a customized collaborative web portal server application;
a user computer operatively coupled to the portal computing device, the user computer including a user interface of a web browser and adapted to display a hierarchy of interlinked portal web pages provided by the portal computing device;
a data store means operatively coupled to the portal computing device and adapted to store litigation-related data;
an interface means for importing personnel information to the portal computing device, the personnel information including custodian information associated with a plurality of custodians having potentially discoverable information related to at least one litigation case; and
a structured query language server operatively coupled to the portal computing device and the data store means, the structured query language server adapted to populate the hierarchy of interlinked portal web pages with at least one of the custodian information and the litigation-related data to facilitate managing litigation activities.

2. The system of claim 1, further comprising a community accessed via the web portal on the user interface, the community including one or more users having permissioned access to the hierarchy of interlinked portal web pages.

3. The system of claim 2, further comprising an active directory server operatively coupled to the portal computing device and the structured query language server, the active directory server adapted to identify a user requesting access to the web portal and to authenticate access to the at least one of the custodian information and the litigation-related data via the hierarchy of interlinked portal web pages.

4. The system of claim 1, wherein the customized collaborative web portal server application comprises one of a Microsoft SharePoint Portal Server 2003 plus customized web parts and a Microsoft Office SharePoint Server 2007 plus customized web parts, the customized web parts adapted to enable:
user selection of the plurality of custodians from the imported personnel information,
automatic transmission of notices to preserve discoverable information to all of the plurality of custodians in response to one user selection,
automatic transmission of the notices to preserve discoverable information to a portion of the plurality of custodians, and
automatic transmission of reminder notices to preserve discoverable information to the plurality of custodians who have not acknowledged receipt of one of the notices to preserve discoverable information.

5. The system of claim 1, wherein the plurality of custodians includes employees internal to an organization that is a party in the at least one litigation case, and wherein the plurality of custodians includes employees external to the organization that is a party in the at least one litigation case.

6. A system for providing a web portal for managing litigation activities, the system comprising:
a portal computing device including a customized collaborative web portal server application;
a user computer operatively coupled to the portal computing device, the user computer including a user interface of a web browser and adapted to display a hierarchy of interlinked portal web pages provided by the portal computing device;
a data store means operatively coupled to the portal computing device and adapted to store litigation-related data; and
an interface means for importing personnel information to the portal computing device, the personnel information including custodian information associated with a plurality of custodians having potentially discoverable information related to one litigation case,
wherein the customized collaborative web portal server application comprises one of a Microsoft SharePoint Portal Server 2003 plus customized web parts and a Microsoft Office SharePoint Server 2007 plus customized web parts, the customized web parts adapted to enable:
user selection of the plurality of custodians from the imported personnel information,
automatic transmission and tracking of notices to preserve discoverable information to all of the plurality of custodians in response to one user selection,
automatic transmission and tracking of the notices to preserve discoverable information to a portion of the plurality of custodians, and
automatic transmission and tracking of reminder notices to preserve discoverable information to the plurality of custodians who have not acknowledged receipt of one of the notices to preserve discoverable information.

7. The system of claim 6, further comprising a structured query language server operatively coupled to the portal computing device and the data store means, the structured query language server adapted to populate the hierarchy of interlinked portal web pages with at least one of the custodian information and the litigation-related data to facilitate managing litigation activities.

8. The system of claim 6, further comprising a community accessed via the web portal on the user interface, the community including one or more users having permissioned access to the hierarchy of interlinked portal web pages and capable of sharing resources.

9. The system of claim 8, further comprising an active directory server operatively coupled to the portal computing device and the structured query language server, the active directory server adapted to identify a user requesting access to the web portal and to authenticate access to the at least one of the custodian information and the litigation-related data via the hierarchy of interlinked portal web pages.

10. A computer-implemented method for providing a web portal for managing litigation activities, the method comprising:
enabling configuration of a customized collaborative web portal server application, the configuration facilitating display of a hierarchy of interlinked portal web pages;
enabling importation of personnel information, the personnel information including custodian information of a plurality of custodians having potentially discoverable information related to at least one litigation case;
displaying a first page of the hierarchy of interlinked portal web pages, the first page including litigation-related data and adapted to enable user selection of the plurality of custodians from the personnel information;
displaying a second page of the page of the hierarchy of interlinked portal web pages, the second page including the litigation-related data and adapted to enable automatic transmission of notices to preserve discoverable information to all of the plurality of custodians in response to one user selection;
displaying a third page of the hierarchy of interlinked portal web pages, the third page including the litigation-related data and adapted to enable automatic transmission of the notices to preserve discoverable information to a portion of the plurality of custodians; and
automatically tracking aspects of the litigation-related data, the custodian information and the notices to preserve discoverable information.

11. The method of claim 10, wherein the second and third pages are further adapted to enable:
automatic transmission of other notices to preserve discoverable information that are different from the notices to preserve discoverable information;
automatic transmission of reminder notices to preserve discoverable information to custodians of the plurality of custodians that have not acknowledged receipt of at least one of the notices to preserve discoverable information; and
user selection of a frequency for transmission of the reminder notices to preserve discoverable information.

12. The method of claim 11, wherein the second page is further adapted to enable user selection of the third page.

13. The method of claim 11, wherein the third page is further adapted to enable:
display of a portion of an alphabetically-ordered list of names of the plurality of custodians, the list of names searchable using a numerical pagination bar displayed on the third page, each of the names of the plurality of custodians associated with a check-box, each of the portion of the plurality of custodians selected by the user via the associated check-box; and
user selection of the second page.

14. The method of claim 11, wherein each of the notices to preserve discoverable information, the other notices to preserve discoverable information and the reminder notices to preserve discoverable information include an acknowledgement link selectable by a receiving custodian of the plurality of custodians.

15. The method of claim 10, wherein, after user access to the web portal is established, each of the hierarchy of interlinked portal web pages is dynamically displayed upon a user selection from another of the hierarchy of interlinked portal web pages.

16. The method of claim 10, wherein each of the hierarchy of interlinked portal web pages is populated with at least one of the custodian information and the litigation-related data.

17. A computer-readable medium having computer-executable instructions thereon that when executed by one or more processors causes a system to:
provide a collaborative web portal including a customized collaborative web portal server application, the collaborative web portal facilitating display of a hierarchy of interlinked portal web pages;
import personnel information, the personnel information including custodian information of a plurality of custodians having potentially discoverable information related to at least one litigation case;
display a first page of the hierarchy of interlinked portal web pages, the first page including litigation-related data and adapted to enable user selection of the plurality of custodians from the personnel information;
display a second page of the hierarchy of interlinked portal web pages, the second page including the litigation-related data and adapted to enable automatic transmission of notices to preserve discoverable information to all of the plurality of custodians in response to one user selection;
display a third page of the hierarchy of interlinked portal web pages, the third page including the litigation-related data and adapted to enable automatic transmission of the notices to preserve discoverable information to a portion of the plurality of custodians; and
automatically track aspects of the litigation-related data, the custodian information and the notices to preserve discoverable information.

18. The computer-readable medium having computer-executable instructions thereon of claim 17, that when executed by one or more processors causes a system to:
automatically transmit other notices to preserve discoverable information that are different from the notices to preserve discoverable information;
automatically transmit of reminder notices to preserve discoverable information to custodians of the plurality of custodians that have not acknowledged receipt of at least one of the notices to preserve discoverable information; and
enable user selection of a frequency for transmission of the reminder notices to preserve discoverable information.

19. The computer-readable medium having computer-executable instructions thereon of claim 17, that when executed by one or more processors causes a system to:
display a portion of an alphabetically-ordered list of names of the plurality of custodians, the list of names searchable using a numerical pagination bar displayed on the third page, each of the names of the plurality of custodians associated with a check-box, each of the portion of the plurality of custodians selected by the user via the associated check-box.
